(19) United States
(12) Patent Application Publication
(10) Pub. No.: US 2026/0208002 A1
(43) Pub. Date: Jul. 23, 2026

(54) BALL DISPENSER FOR MINIATURE GOLF COURSE

(71) Applicant: Puttshack LTD, London (GB)

(72) Inventors: Samuel Nicolas Jones, Scraptoft (GB); Stephen Peter Slade, Tonbridge (GB); Maria Alejandra Betti, Abingdon (GB); Thomas Alan Lloyd, Hayes (GB); Ashley Marc Pemberton, Hawkinge (GB); Thomas Stephen David Hopkinson, Reading (GB)

(21) Appl. No.: 19/456,237

(22) Filed: Jan. 22, 2026

Related U.S. Application Data
(60) Provisional application No. 63/748,257, filed on Jan. 22, 2025.

(51) Int. Cl. A63B 47/00; A63B 67/02; B65G 1/04; G07F 11/34

(52) U.S. Cl. CPC A63B 47/002; B65G 1/04; G07F 11/34; A63B 67/02; A63B 2225/50

(57) ABSTRACT

A ball dispenser includes a dispensing rail, a magnet to temporarily awaken electronics of a golf ball from a sleep state after said golf ball has been transferred onto the dispensing rail, a wireless transceiver, a dispensing gate to dispense said golf ball, and a ball ram to discard said golf ball to prevent subsequent dispensing. A controller is configured to receive, via the wireless transceiver, an identification code and a battery-health indicator from said golf ball when said electronics is temporarily activated. In response to receiving a ball request and determining said battery-health indicator is greater than a predetermined threshold, the controller is configured to send a dispense signal to cause the dispensing gate to actuate to dispense said golf ball and subsequently send a clear signal to the ball ram to discard of any golf ball remaining on the dispensing rail.

### CROSS-REFERENCE TO RELATED APPLICATION

This application claims the benefit of U.S. Provisional Patent Application No. 63/748,257 , filed Jan. 22, 2025, which is incorporated by reference herein in its entirety.

### TECHNICAL FIELD

The present disclosure generally relates to miniature golf and, more specifically, to a ball dispenser for a miniature golf course.

### BACKGROUND

Miniature golf (also referred to as “minigolf” or “putt-putt”) is a game that is typically played on a miniature golf course with a series of holes. Each player is to putt a respective ball into each of the series of holes. Oftentimes, each hole in a miniature golf course includes one or more artificial obstacles and/or unusual geometric arrangements to make putting a ball into the hole more difficult and entertaining. Example obstacles may include ramps, tubes, curved or angled walls, windmills, etc.

Relatively recently, some miniature golf courses have entered the digital world. Instead of relying on players to keep score on a scorecard via pen and paper, some recent miniature golf courses use sensors (e.g., cameras, global positioning system (GPS) units, accelerometers, magnetometers, gyroscopes, etc.) to detect when a player has performed a stroke and/or track motion of a golf ball along a hole.

For instance, some courses use golf balls in which one or more such sensors are incorporated to detect strokes and/or track motion of the golf balls. Typically, such golf balls also incorporate one or more batteries to power the use of the sensors. The sensors in the golf balls can have relatively high energy consumptions, which may result in draining the charge levels of the corresponding batteries more quickly. The battery of each golf ball may potentially be drained by the corresponding sensor(s) both (i) while the golf ball is being used by a player during a round of miniature golf and (ii) in between rounds while the golf ball is in storage waiting to be dispensed to another player.

### SUMMARY

The present document discloses aspects of embodiments and should not be used to limit the scope of the claims. Other embodiments are contemplated in accordance with the techniques described herein, as will be apparent to one having ordinary skill in the art upon examination of the following drawings and detailed description, and these embodiments are intended to be within the scope of this disclosure.

Example embodiments are shown for a ball dispenser for a miniature golf course.

An example ball dispenser includes a dispensing rail including an outlet end and on which a first set of golf balls is to rest. The ball dispenser includes a magnet adjacent the dispensing rail and configured to temporarily awaken electronics of each golf ball of the first set of golf balls from a respective sleep state. The ball dispenser includes a wireless transceiver, a dispensing gate at the outlet end of the dispensing rail, and a controller. The controller is configured to receive, via the wireless transceiver, an identification code and a battery-health indicator from each golf ball of the first set of golf balls when the respective electronics is temporarily activated. The controller is configured to identify, based on communication with the wireless transceiver, a next-in-line ball from the first set of golf balls that is closest to the outlet end and identify the battery-health indicator of the next-in-line ball. The controller is configured to send a dispense signal to cause the dispensing gate to dispense the next-in-line ball in the respective sleep state in response to receiving a dispense command and determining that the battery-health indicator of the next-in-line ball is greater than a predetermined threshold.

Another example ball dispenser includes a dispensing rail including a receiving end and an outlet end, a magnet positioned along the dispensing rail and configured to temporarily awaken electronics of a golf ball from a sleep state after said golf ball has been transferred onto the dispensing rail, a wireless transceiver positioned adjacent the dispensing rail, a dispensing gate positioned adjacent the outlet end of the dispensing rail and configured to dispense said golf ball, a ball ram positioned adjacent the outlet end of the dispensing rail and configured to discard said golf ball to prevent subsequent dispensing, and a controller. The controller is configured to receive, via the wireless transceiver, an identification code and a battery-health indicator from said golf ball when said electronics is temporarily activated. The controller is configured to compare said battery-health indicator to a predetermined threshold, send a discard signal to cause the ball ram to discard said golf ball in response to determining that said battery-health indicator is less than or equal to the predetermined threshold, and send a dispense signal to cause the dispensing gate to dispense said golf ball in response to receiving a ball request and determining said battery-health indicator is greater than a predetermined threshold.

Yet another example ball dispenser includes a dispensing rail including a receiving end and an outlet end, a magnet positioned along the dispensing rail and configured to temporarily awaken electronics of a golf ball from a sleep state after said golf ball has been transferred onto the dispensing rail, a wireless transceiver positioned adjacent the dispensing rail, a dispensing gate positioned adjacent the outlet end of the dispensing rail and configured to dispense said golf ball, a ball ram positioned adjacent the outlet end of the dispensing rail and configured to discard said golf ball to prevent subsequent dispensing, and a controller. The controller is configured to receive, via the wireless transceiver, an identification code and a battery-health indicator from said golf ball when said electronics is temporarily activated. The controller is configured to compare said battery-health indicator to a predetermined threshold. The controller, in response to receiving a ball request and determining said battery-health indicator is greater than a predetermined threshold, is configured to send a dispense signal to cause the dispensing gate to actuate to dispense said golf ball and subsequently send a clear signal to the ball ram to discard of any golf ball remaining on the dispensing rail.

A golf course, game assembly, and/or facility may include any of the example ball dispensers.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an exterior of an example ball dispenser.

FIG. 2 illustrates the ball dispenser of FIG. 1 with a portion of a housing removed to depict internal components of the ball dispenser.

FIGS. 3-4 illustrates an internal frame, a surplus hopper assembly, and a dispense hopper assembly of the ball dispenser of FIG. 1.

FIGS. 5-6 illustrate a ball gate of the surplus hopper assembly of FIGS. 3-4.

FIGS. 7-8 further illustrate the dispense hopper assembly of FIGS. 3-4.

FIG. 9 further illustrates the dispense hopper assembly of FIGS. 3-4 with a portion of a Faraday shield removed to depict other components of the dispense hopper assembly.

FIGS. 10-11 further illustrate the dispense hopper assembly of FIGS. 3-4 without the Faraday shield to depict other components of the dispense hopper assembly.

FIG. 12 illustrates another example ball dispenser with a portion of a housing removed to depict internal components of the ball dispenser.

FIG. 13 illustrates an upper hopper assembly and a lower hopper assembly of the ball dispenser of FIG. 12.

FIG. 14-15 further illustrate the lower hopper assembly of the ball dispenser of FIG. 13.

FIG. 16 is a block diagram depicting electronics of the ball dispenser of FIG. 1.

FIG. 17 is a flowchart of an example method for operating the ball dispenser of FIG. 1 and the ball dispenser of FIG. 12.

FIG. 18 is a flowchart of another example method for operating the ball dispenser of FIG. 1 and the ball dispenser of FIG. 12.

FIG. 19 is a flowchart of an example subroutine of FIG. 18 for method for positioning a ball for subsequent dispensing.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example ball dispensers are disclosed herein. Each ball dispenser is configured to store a plurality of electrified balls waiting to be dispensed to corresponding players. The ball dispenser awakens the electronics of each ball to check the charge level of the respective ball. If the charge level is insufficient, the ball dispenser discards of the ball to prevent it from being dispensed to a player. In contrast, if the charge level is sufficient, the ball dispenser eventually dispenses the ball to a player for subsequent use. The ball dispenser only briefly awakens the electronics of each ball to check the health status of the battery. Otherwise, the ball dispenser keeps the electronics of each of the balls in a respective sleep state to prolong the life of the battery of each ball without needing to repeatedly recharge the respective battery. In turn, the ball dispenser ensures that only healthy electrified balls are dispensed to players, while also prolonging the life of each electrified ball.

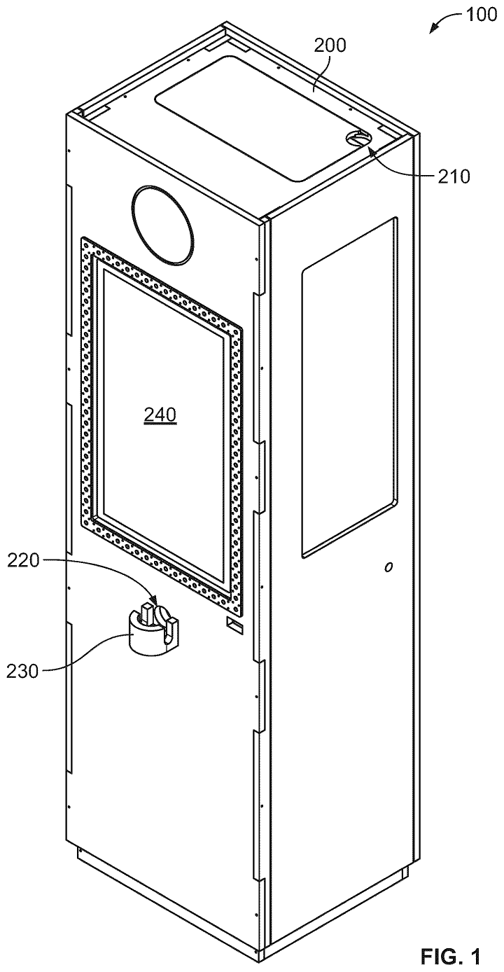

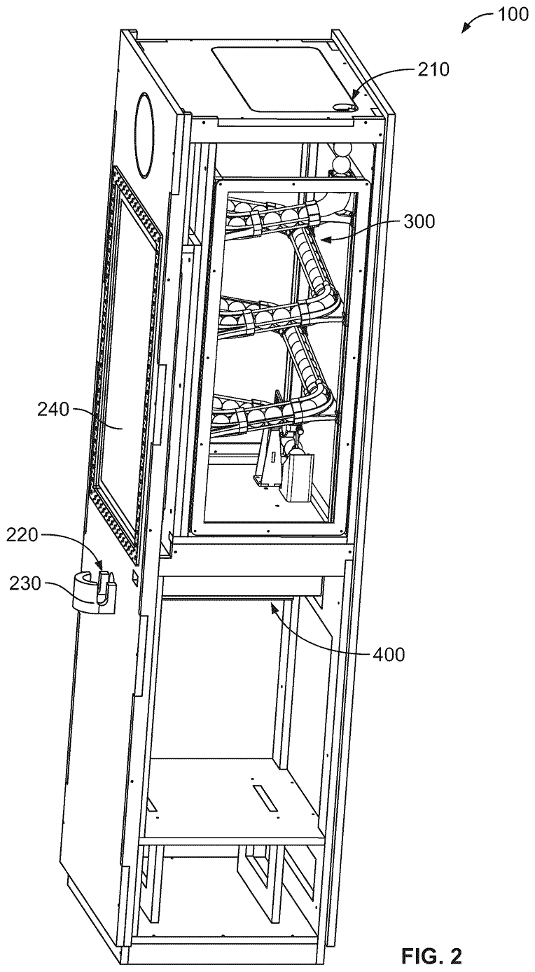

FIGS. 1-2 illustrate an example ball dispenser 100 of a golf course, game assembly, and/or facility with one or more holes. The ball dispenser 100 includes a housing 200 in which other components, such as a surplus hopper assembly 300 and a dispense hopper assembly 400, of the ball dispenser 100 are enclosed. As disclosed below in greater detail, the ball dispenser 100 is configured to store a plurality of golf balls and dispense one of those golf balls to a player upon command.

Each of the golf balls include electronics that enable the subsequent movement of the golf balls to be monitored along the golf course. For example, each golf ball may also include (1) a processor; (2) memory; (3) one or more sensors to detect movement and/or track the location of the golf ball along the golf course; (4) a wireless transceiver to relay ball data (e.g., an identification code) to a remote computing device; and/or (5) a battery to power the other electronics of the golf ball. As disclosed below in greater detail, the ball dispenser 100 keeps each of the golf balls in respective sleeps states for as much as possible. The ball dispenser 100 only briefly awakens the electronics of each of the golf balls to check the respective charge level prior to determine whether to dispense or discard of the golf ball, thereby prolonging the life of the battery of each golf ball without needing to repeatedly recharge the battery.

The housing 200 defines an inlet hole 210 and an outlet hole 220. The inlet hole is configured to receive golf balls from a source (e.g., the last hole of a miniature golf course) for subsequent storage in the ball dispenser 100. The outlet hole 220 through which a golf ball is to be dispensed to a player for a round on the miniature golf course. The housing 200 also includes a tray 230 positioned below the outlet hole 220. The tray 230 is to facilitate players in gathering respective golf balls that have been dispensed. Specifically, the tray 230 is positioned such that a golf ball is to rest on the tray 230 upon being dispensed through the outlet hole 220.

In the illustrated example, the ball dispenser 100 also includes a touchscreen 240 that is mounted to the housing 200. The touchscreen 240 is an input and output device that is configured to receive requests from players for the ball dispenser 100 to dispense golf balls. In other examples, the ball dispenser 100 may include other user input and/or output device(s) that enable players to request for the dispensing of golf balls. In yet other examples, the ball dispenser 100 may receive the requests from remote devices, such as mobile devices (e.g., smartphones, tablets, smart watches, etc.) of the players.

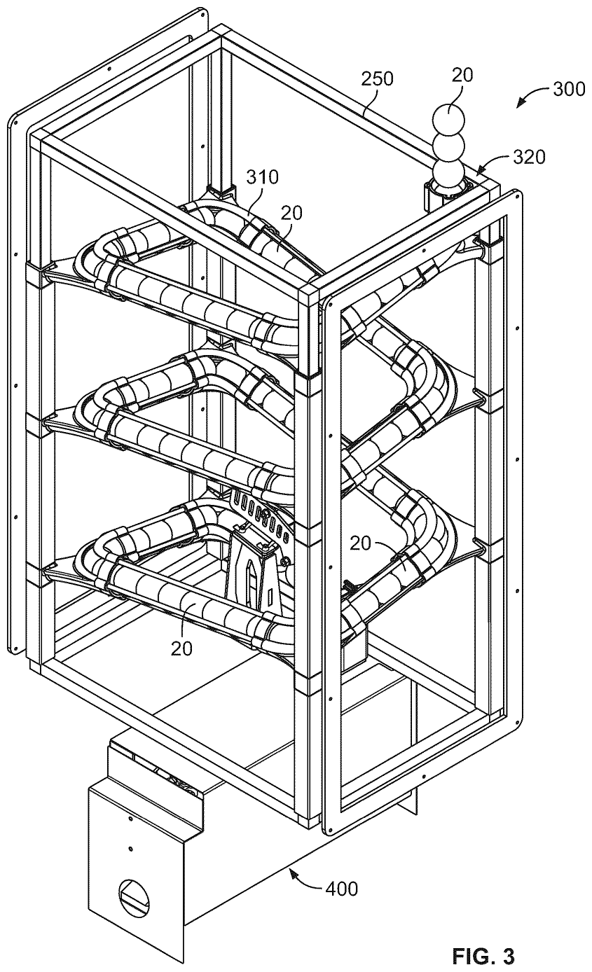

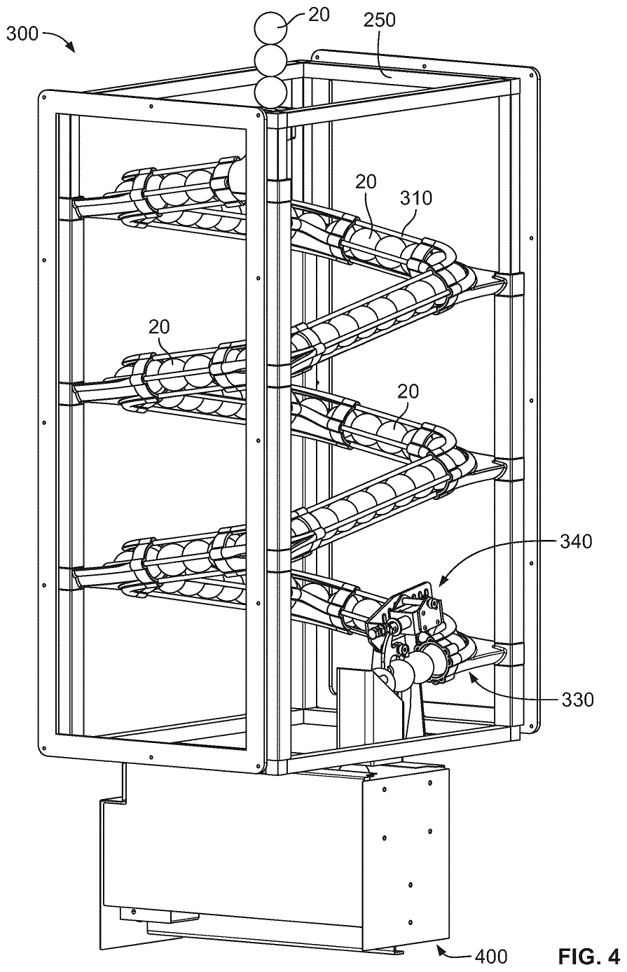

Turning to FIGS. 3-4, the ball dispenser 100 includes a frame 250, the surplus hopper assembly 300, and the dispense hopper assembly 400 that are housed in the housing 200. The surplus hopper assembly 300 and the dispense hopper assembly 400 are mounted to the frame 250.

The surplus hopper assembly 300 (also referred to as an “upper hopper assembly” and a “second hopper assembly”) includes a rail 310 (also referred to as a “surplus rail,” an “upper rail,” and a “second rail”) and a ball gate 340 (also referred to as a “surplus gate,” a “transfer gate,” an “upper gate,” and a “second gate”).

The rail 310 includes an inlet end 320 (also referred to as a “surplus inlet end”) and an outlet end 330 (also referred to as a “surplus inlet end” and the “transfer end”). The rail 310 and the housing 200 are arranged such that the inlet end 320 of the rail 310 is adjacent the inlet hole 210 of the housing 200. Golf balls 20, while in their respective sleep states, are fed from a source (e.g., the last hole of a miniature golf course), through the inlet hole 210 and onto the inlet end 320 of the rail 310. That is, the inlet end 320 of the rail 310 is configured to receive the golf balls 20 in their sleep states.

The rail 310 is arranged such that the golf balls 20 (also referred to as “surplus balls” and “a second set of golf balls”) are to rest on and travel along the rail 310. Specifically, the golf balls 20 are to travel along the rail 310 from the inlet end 320 and to the outlet end 330 while in their respective sleep states. The rail 310 is arranged in a spiral pattern to optimize the number of the golf balls 20 that may rest on the rail 310 within the housing 200 at any given time. The rail 310 is also configured to deter the golf balls 20 from becoming jammed while resting on the rail 310. For example, the rail 310 angled downward by at least a predefined angle (10 degrees) that enables gravity to deter jamming along the rail 310. Additionally or alternatively, the rail 310 is formed of a plurality of rods that extend parallel to each other and are arranged to deter friction between the rail 310 and the golf balls 20. In the illustrated example, the rail 310 includes four rods (a lower rod, an upper rod, and opposing side rods) that are arranged to reduce friction, while also preventing the golf balls 20 from falling off the rail 310.

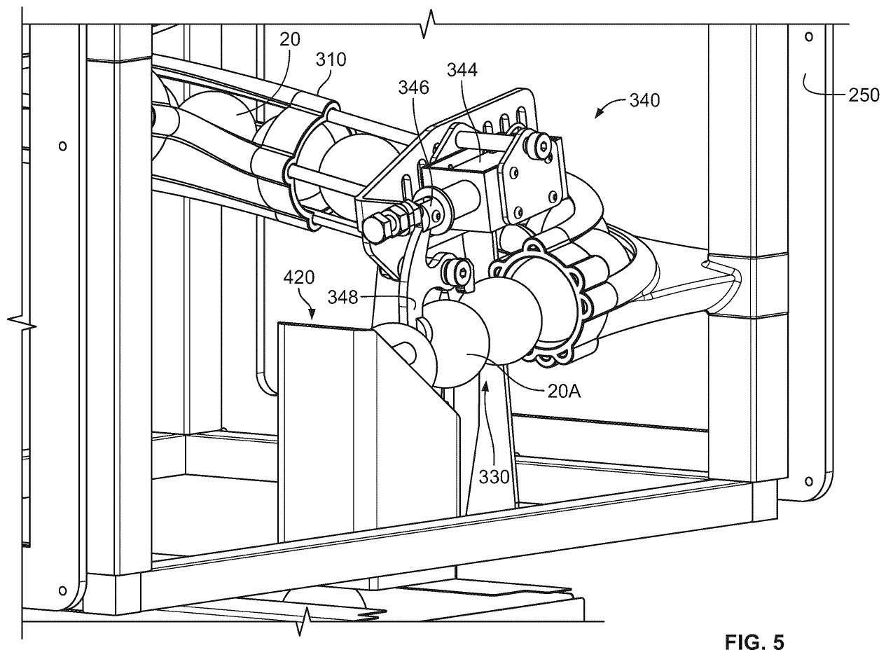

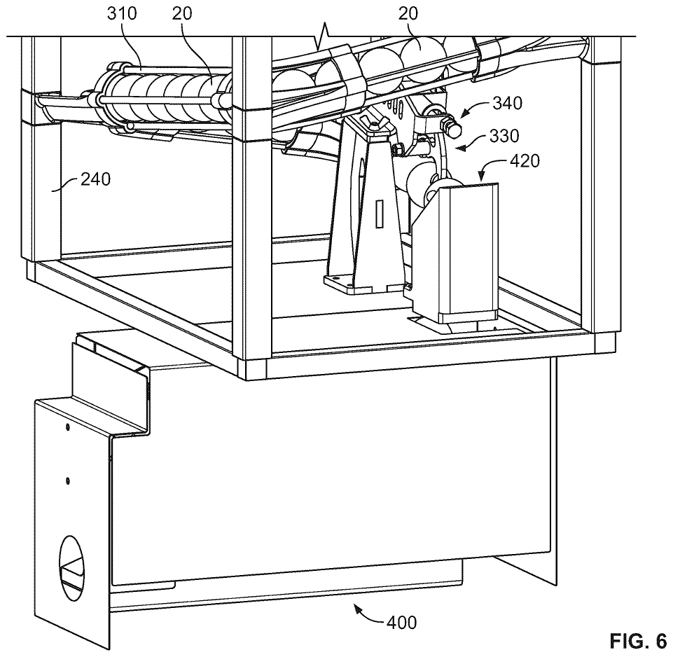

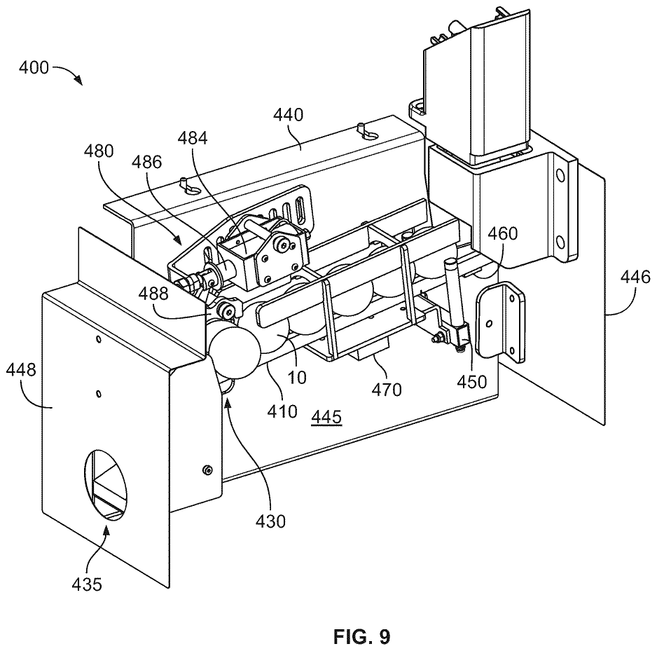

Turning to FIGS. 5-6, the ball gate 340 is located at the outlet end 330 of the rail 310. The ball gate 340 is configured to transfer a next golf ball 20A of the golf balls 20 from the rail 310 of the surplus hopper assembly 300 and onto a rail 410 (FIGS. 9-11) of the dispense hopper assembly 400 while the next golf ball 20A remains in its sleep state. As disclosed below in greater detail, the ball gate 340 is configured to transfer the next golf ball 20A onto the rail 410 when the dispense hopper assembly 400 is not at capacity.

As shown in FIG. 5, the ball gate 340 includes an actuator 344 and a ball stopper 348. The actuator 344 includes a shaft 346, and the ball stopper 348 pivotably coupled to the shaft 346. In some examples, the actuator 344 is a solenoid actuator. The shaft 346 is configured to actuate between a retracted position and an extended position to actuate the ball gate 340 between its stop position and its transfer position, respectively. For example, the ball gate 340 is positioned above the rail 310 such that the ball stopper 348 is configured to swing downward and upward as the ball gate 340 transitions between its stop and transfer positions, respectively. In the stop position, the ball stopper 348 is positioned (e.g., lowered), via the actuator 344, to stop any of the golf balls 20 from being transferred from the rail 310. In the transfer position, the ball stopper 348 is positioned (e.g., raised), via the actuator 344, to permit the next golf ball 20A to be transferred onto the rail 410.

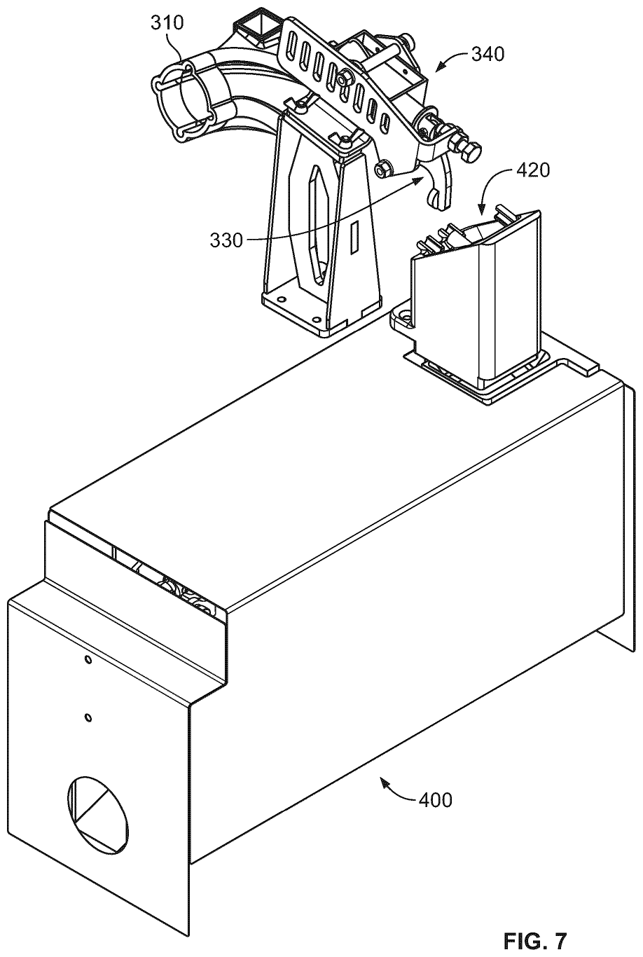

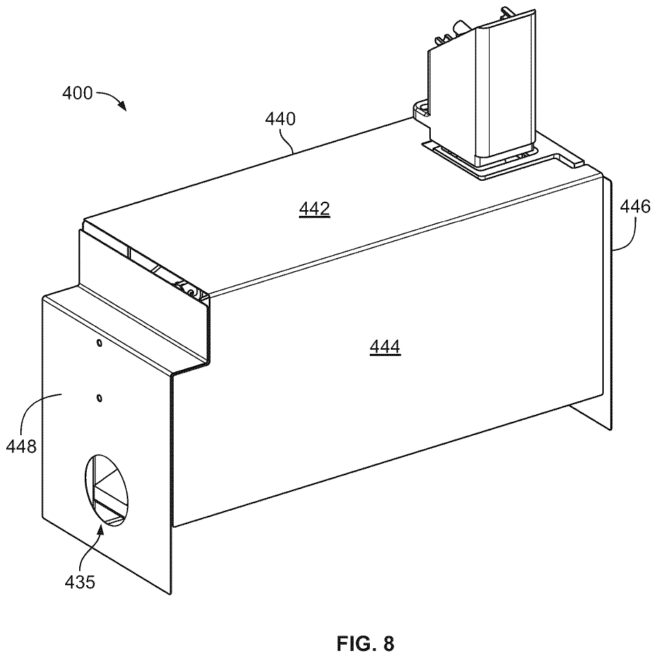

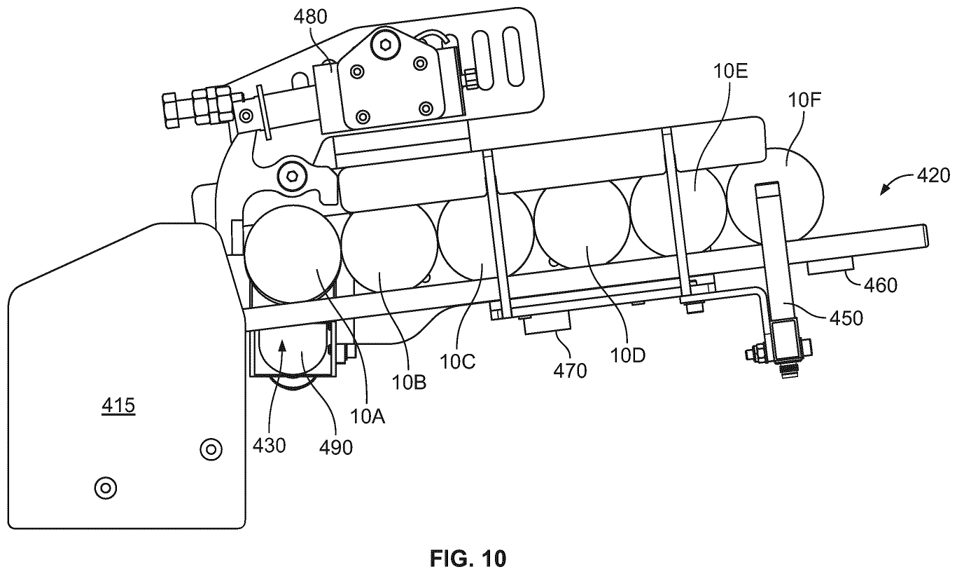

Turning to FIGS. 7-8, the dispense hopper assembly 400 includes a Faraday shield 440 that encloses, at least partially, other components of the dispense hopper assembly 400. The Faraday shield 440 is configured to prevent those components at least partially enclosed by the Faraday shield (e.g., a magnet 460 and/or a transceiver 470 of FIGS. 9-10) from wirelessly communicating with other electronic devices external to the Faraday shield 440.

The Faraday shield 440 is formed of a plurality of panels. As shown in FIGS. 8-9, the Faraday shield 440 includes an upper panel 442, a side panel 444, an opposing side panel 445, an end panel 446 (also referred to as an “inlet end panel”), and an opposing end panel 448 (also referred to as an “outlet end panel”). The end panel 448 defines an outlet opening 435 that is configured to be positioned adjacent to the outlet hole 220 of the housing 200 and through which golf balls are dispensed. In some examples, each of the panels of the Faraday shield 440 includes a sheet of RFID-blocking fabric that is bonded to an aluminum backing sheet.

One or more of the panels of the Faraday shield 440 may be integrally and monolithically formed with each other. Additionally or alternatively, one or more of the panels of the Faraday shield 440 may be separately formed and coupled together (e.g., via fasteners). In the illustrated example, the upper panel 442 and the side panel 444 are integrally and monolithically formed with a hinged connection between the two. The hinged connection the upper panel 442 and the side panel 444 facilitates an operator in accessing other components of the dispense hopper assembly 400 for servicing. Further, the side panel 445, the end panel 446, and the end panel 448 of the illustrated example couple together and with the upper panel 442 and the side panel 444 via fasteners.

Turning to FIGS. 9-11, the dispense hopper assembly 400 (also referred to as a “lower hopper assembly” and a “first hopper assembly”) includes a rail 410 (also referred to as a “dispensing rail,” a “lower rail,” and a “first rail”). The rail 410 includes an inlet end 420 (also referred to as a “dispense inlet end” and a “receiving end”) and an outlet end 430 (also referred to as a “dispense end” and a “dispense outlet end”). An outlet ramp 415 is positioned between the outlet end 430 of the rail 410 and the outlet opening 435 of the Faraday shield 440. The rail 410, the outlet ramp 415, and the housing 200 are arranged such that golf balls 10, while in their respective sleep states, are dispensed from the rail 410, along the outlet ramp 415, through the outlet opening 435 and the outlet hole 220, and onto the tray 230.

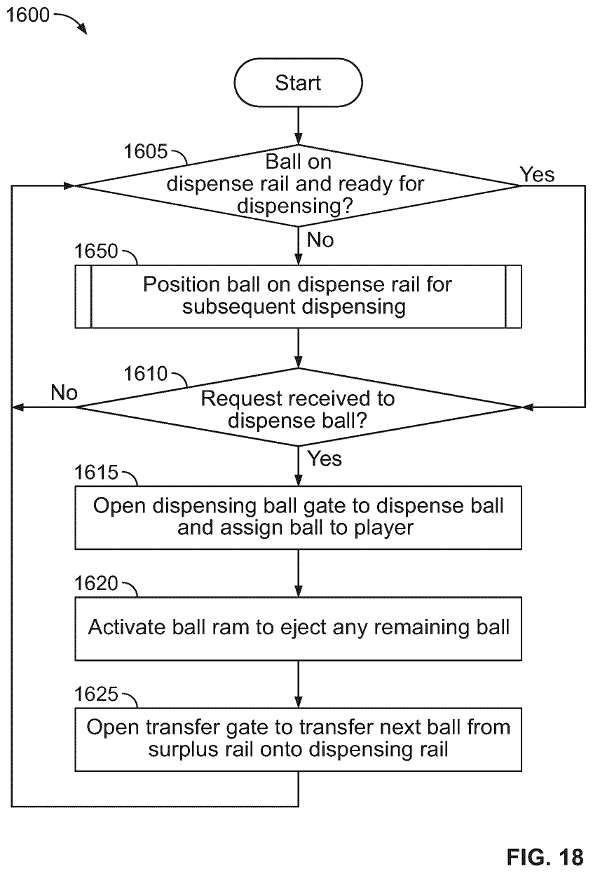

The rail 410 is arranged such that the golf balls 10 (also referred to as “dispense balls” and “a first set of golf balls”) are to rest on and travel along the rail 410. Specifically, the golf balls 10 are to travel along the rail 410 from the inlet end 420 and to the outlet end 430. In the illustrated example, the rail 410 has a capacity of six golf balls. For example, the golf balls 10 include golf balls 10A-10F, with the golf ball 10A (also referred to as a “next-in-line ball”) positioned adjacent the outlet end 430 and the golf ball 10F (also referred to as a “last-in-line ball”) being positioned adjacent the inlet end 420. The next-in-line golf ball 10A is the next golf ball to be dispensed to a player, and the golf ball 10F is the most recent of the golf balls 10 to be transferred onto the rail 410. In other examples, the ball dispenser 100 is configured (see the method of operation of FIG. 18) so that only one golf ball 10 is positioned on the rail 410 at a time.

The rail 410 is arranged to deter the golf balls 10 from becoming jammed while resting on the rail 410. For example, the rail 410 angled downward by at least a predefined angle (10 degrees) that enables gravity to deter jamming along the rail 410. Additionally or alternatively, the rail 410 is formed of a plurality of rods and/or side walls that extend parallel to each other and are arranged to deter friction between the rail 410 and the golf balls 10. In the illustrated example, the rail 410 includes two lower rods (a lower left rod and a lower right rod) and two side walls (a left side wall and a right side wall) that are arranged to reduce friction, while also preventing the golf balls 10 from unintentionally falling off the rail 410.

The dispense hopper assembly 400 of the illustrated example includes a ball sensor 450. In the illustrated example, the ball sensor 450 includes a fork sensor adjacent the inlet end 420 of the rail 410. The ball sensor 450 is configured to detect whether one of the golf balls 10 is present at the inlet end 420.

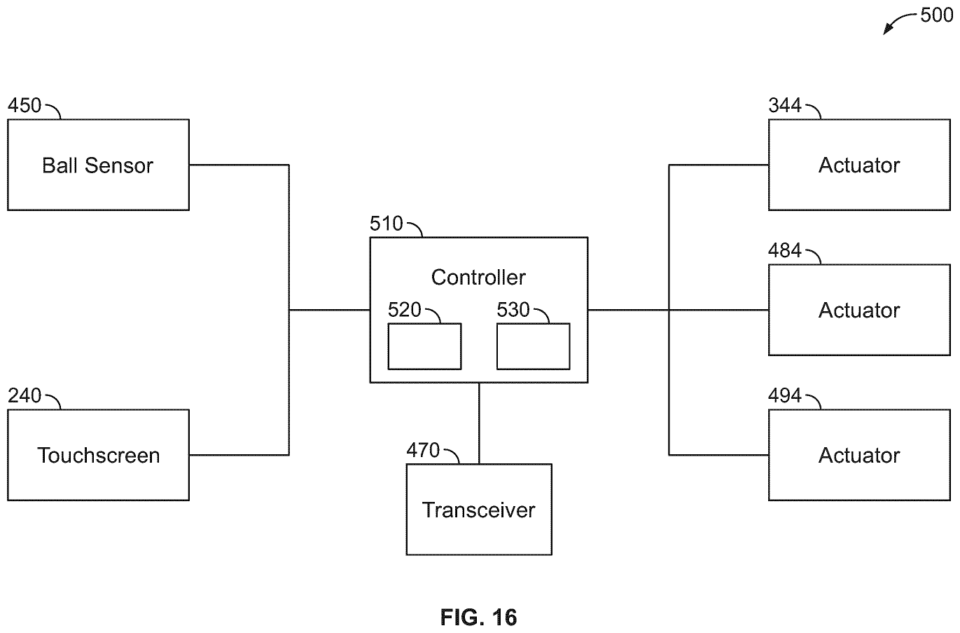

In the illustrated example, a controller (e.g., a controller 510 of FIG. 16) is configured to determine whether the rail 410 is at capacity based on whether the ball sensor 450 detects a presence of one of the golf balls 10 for at least a predetermined duration (also referred to as “a predetermined not-at-capacity duration” and a “first predetermined duration”). For example, the controller is configured to determine that the rail 410 is not at capacity in response to the ball sensor 450 not detecting one of the golf balls 10 for at least the predetermined duration. In contrast, the controller is configured to determine that the rail 410 is at capacity in response to the ball sensor 450 detecting one of the golf balls 10 within at least the predetermined duration. In other examples, the controller is configured so that only one golf ball 10 is positioned on the rail 410 at a time (see the method of operation of FIG. 18) regardless of the physical capacity of the rail 410.

The dispense hopper assembly 400 also includes a magnet 460 that is configured to temporarily awaken the electronics of the golf balls 10 from respective sleep states. The magnet 460 is positioned along and/or adjacent (e.g., below) the rail 410 to awaken each of the golf balls 10 as they roll along the rail 410. For example, the magnet 460 is adjacent the inlet end 420 of the rail 410 to activate each of the golf balls 10 shortly after being transferred onto the rail 410. The magnet 460 is enclosed by the Faraday shield 440 to prevent the magnet 460 from activating the electronics of the golf balls 20 and/or other electronic devices (e.g., other golf balls) outside of the dispense hopper assembly 400.

In some examples, the magnet 460 is a permanent magnet that is configured to activate only one of the golf balls 10 at a time. In such examples, as is shown in FIG. 10, the magnet 460 may be adjacent the ball sensor 450 such that one of the golf balls 10 (e.g., the golf ball 10F) is activated concurrently with or shortly before being detected by the ball sensor 450. In examples in which the magnet 460 is a permanent magnet, the magnetic state of the magnet 460 is not controlled by a controller (e.g., the controller 510 of FIG. 16).

In other examples, the magnet 460 may be an electromagnet whose magnetic state is controlled by the controller. In such examples, the electromagnet may be temporarily activated by the controller to, in turn, temporarily activate the electronics of one or more of the golf balls 10 (e.g., simultaneously) positioned on the rail 410. An electromagnet may be configured to be temporarily activated based on an activation signal received from the controller. In some examples, the controller may be configured to temporarily activate the electromagnet for a predetermined duration (also referred to as a “predetermined activation duration” and a “second predetermined duration”) upon determining that the rail 410 has been at capacity for at least another predetermined duration (also referred to as a “predetermined at-capacity duration” and a “third predetermined duration”).

The dispense hopper assembly 400 includes a transceiver 470 (also referred to as a “wireless transceiver”) configured to wirelessly communicate with wireless transceivers of the golf balls 10 to collect respective identification codes and battery-health indicators (e.g., charge levels) of the golf balls 10. For example, the transceiver 470 is configured to communicate with the respective wireless transceiver of one of the golf balls 10 (e.g., the golf ball 10F as shown in FIG. 10) when the electronics of that golf ball are activated by the magnet 460. In the illustrated example, the transceiver 470 is positioned adjacent the rail 410 and/or enclosed by the Faraday shield 440 to prevent the transceiver 470 from communicating with the golf balls 20 and/or other electronic devices (e.g., other golf balls) outside of the dispense hopper assembly 400.

The dispense hopper assembly 400 also includes both a ball gate 480 and a ball ram 490 positioned at and/or adjacent the outlet end 430 of the rail 410. In the illustrated example, the ball gate 480 is configured to dispense the next-in-line golf ball 10A to the player upon confirmation that the battery of the next-in-line golf ball 10A is in good health (e.g., has a charge level above a predetermined threshold). The ball ram 490 (also referred to as a “ball discarder” a “ball rejecter”) is configured to discard the next-in-line golf ball 10A from the rail 410 to prevent the next-in-line golf ball 10A from being dispensed by the ball gate 480 upon a determination that the battery of the next-in-line golf ball 10A is not be in good health.

As shown in FIG. 9, the ball gate 480 includes an actuator 484 and a ball stopper 488. The actuator 484 includes a shaft 486, and the ball stopper 488 pivotably coupled to the shaft 486. In some examples, the actuator 484 is a solenoid actuator. The shaft 486 is configured to actuate between a retracted position and an extended position to actuate the ball gate 480 between its block position and its dispense position, respectively. The ball stopper 488 is configured to engage the next-in-line golf ball 10A in the block position and disengage from the next-in-line golf ball 10A as the ball gate 480 transitions to the dispense position. For example, the ball gate 480 is positioned above the rail 410 such that the ball stopper 488 is configured to swing downward and upward as the ball gate 480 transitions between its block and dispense positions, respectively. In the block position, the ball stopper 488 is positioned (e.g., lowered), via the actuator 484, to cause the golf balls 10 to temporarily stop any of the golf balls 10 from being dispensed and, in turn, cause the golf balls 10 to rest on the rail 410. In the dispense position, the ball stopper 488 is positioned (e.g., raised), via the actuator 484, to permit the next-in-line golf ball 10A to be dispensed to the player.

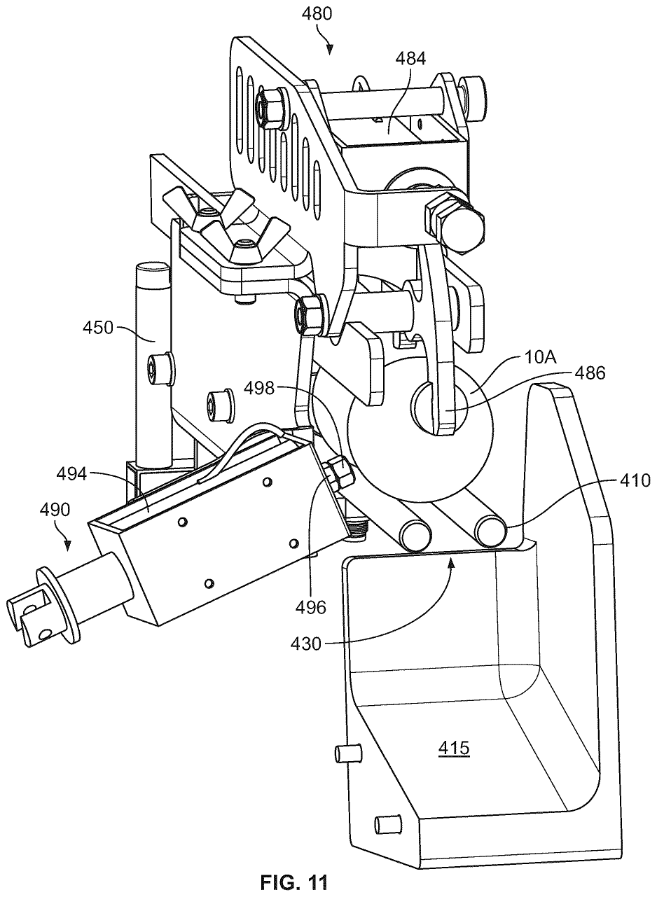

As shown in FIG. 11, the ball ram 490 includes an actuator 494, includes a shaft 496. In some examples, the actuator 494 is a solenoid actuator. The shaft 496 is configured to actuate between a retracted position and an extended position to actuate the ball ram 490 between its rest position and its discard position, respectively. The ball ram 490 is configured to push the next-in-line golf ball 10A from the rail 410 as the ball ram 490 transitions to its discard position. For example, the ball ram 490 is oriented transverse to the rail 410 to enable the shaft 496 of the ball ram 490 to push the next-in-line golf ball 10A off a side of the rail 410. In the rest position, the shaft 496 disengaged from the next-in-line golf ball 10A to enable the next-in-line golf ball 10A to rest in place against the ball stopper 488 of the ball gate 480. When transitioning to the discard position, the shaft 496 extends to contact the next-in-line golf ball 10A with enough force to push the next-in-line golf ball 10A from the rail 410.

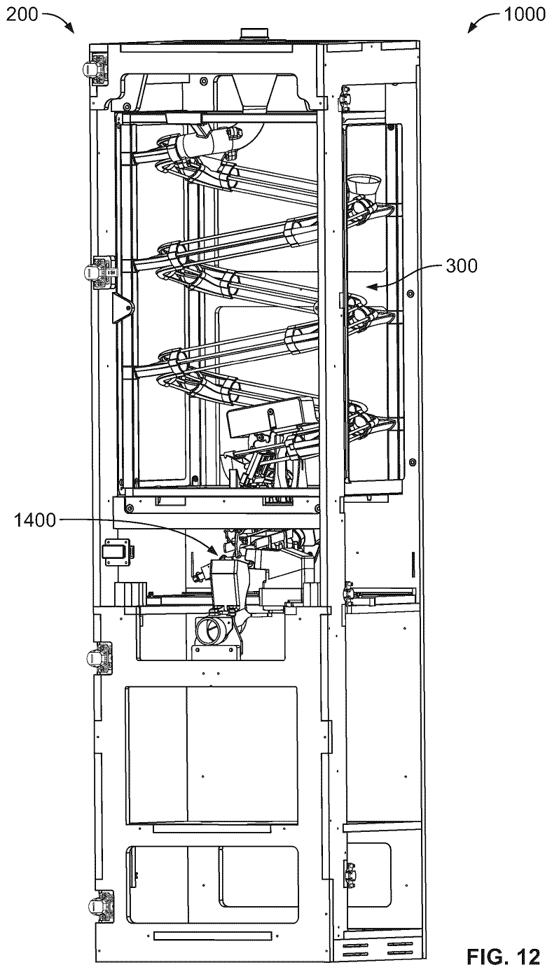

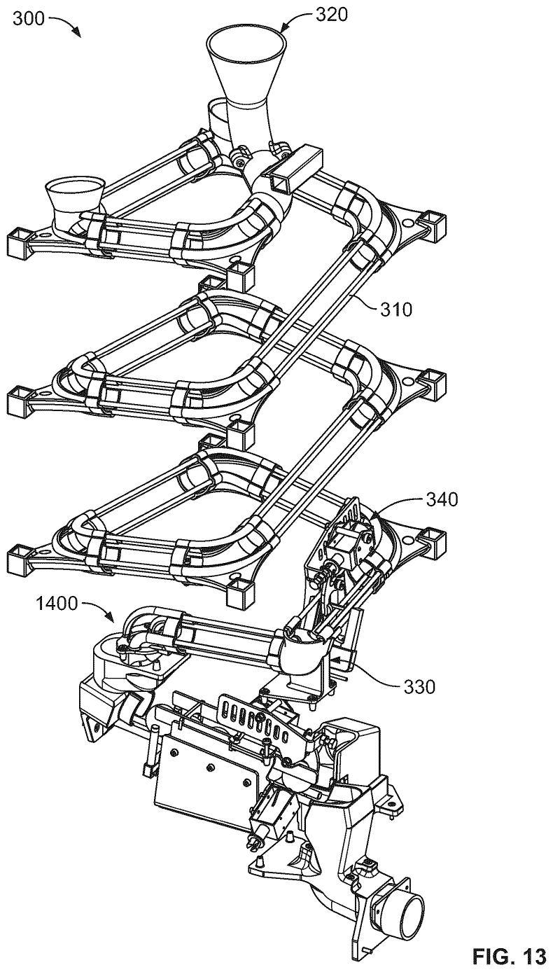

FIGS. 12-15 illustrate another example ball dispenser 1000 of a golf course, game assembly, and/or facility with one or more holes. The ball dispenser 100 includes the housing 200 and the surplus hopper assembly 300, as disclosed with respect to the ball dispenser 100 of FIGS. 1-11. In turn, those components are not described in further detail below with respect to the ball dispenser 1000 for conciseness purposes. The ball dispenser 1000 further includes a dispense hopper assembly 1400 with some features that are identical and/or substantially similar to that of the dispense hopper assembly 400. For example, the dispense hopper assembly 1400 includes the ball sensor 450, the transceiver 470, the ball gate 480, and the ball ram 490, as disclosed with respect to the dispense hopper assembly 400 of FIGS. 2-11. In turn, those components are not described in further detail below with respect to the dispense hopper assembly 1400 for conciseness purposes.

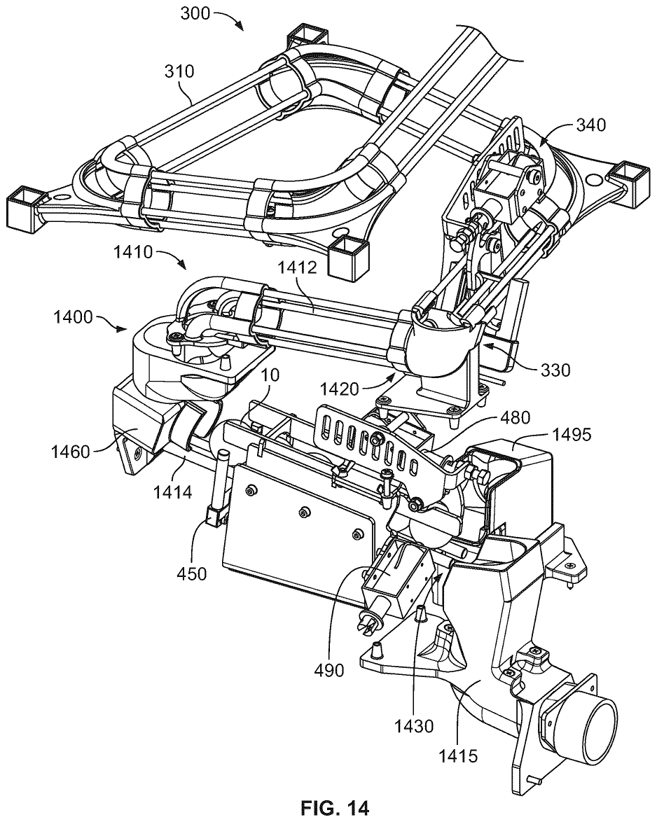

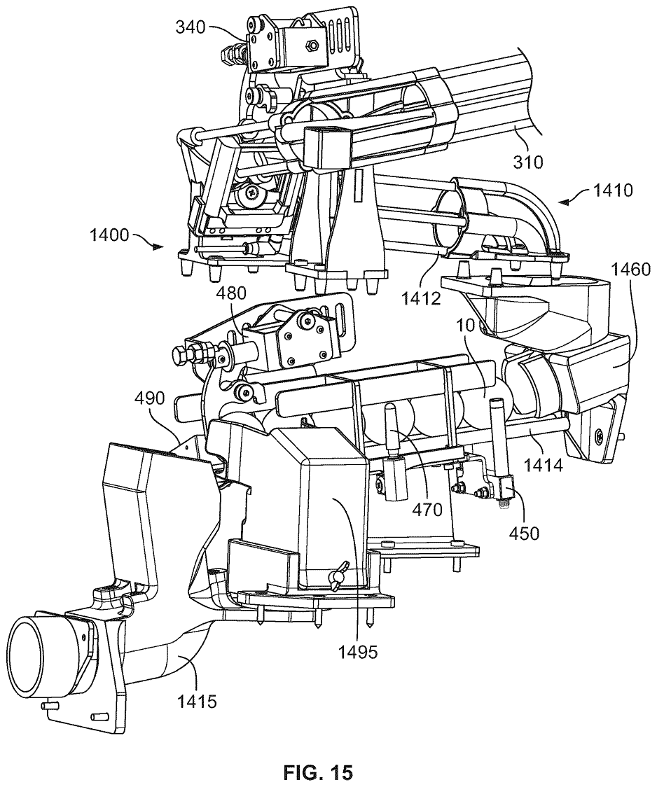

As shown in FIGS. 14-15, the dispense hopper assembly 1400 (also referred to as a “lower hopper assembly” and a “first hopper assembly”) includes a rail 1410 (also referred to as a “dispensing rail” and a “first rail”). In the illustrated example, the rail 1410 includes a rails 1412, 1414. The rail 1412 (also referred to as an “upper dispensing rail” and an “upper first rail”) is configured to receive a golf ball 10 from the surplus hopper assembly 300 and subsequently transfer that ball 10 to the rail 1414, and the rail 1414 (also referred to as a “lower dispensing rail” and a “lower first rail”) is configured to receive a golf ball 10 from the rail 1412 for subsequent dispensing or discarding.

The rail 1410 is arranged to deter the golf balls 10 from becoming jammed while resting on the rail 1410. For example, both the rail 1412 and the rail 1414 are angled downward by at least a predefined angle (10 degrees) that enables gravity to deter jamming along the rail 1410. Additionally or alternatively, each of the rails 1412, 1414 is formed of a plurality of rods and/or side walls that extend parallel to each other and are arranged to deter friction with the golf balls 10. In the illustrated example, each of the rails 1412, 1414 includes two lower rods (a lower left rod and a lower right rod) and two side walls (a left side wall and a right side wall) that are arranged to reduce friction, while also preventing the golf balls 10 from unintentionally falling off the rail 1410.

Further, the rail 1410 includes an inlet end 1420 (also referred to as a “dispense inlet end” and a “receiving end”) at one end of the rail 1412 and an outlet end 430 (also referred to as a “dispense end” and a “dispense outlet end”) at one end of the rail 1414. A dispense channel body 1415 is positioned adjacent the outlet end 1430 to guide a golf ball 10 being dispensed from the rail 1410 and to the tray 230. An eject channel body 1495 is positioned adjacent the outlet end 1430 to guide a golf ball 10 being discarded from the rail 1410.

The dispense hopper assembly 1400 also includes a magnet 1460 that is configured to temporarily awaken the electronics of a golf ball 10 from its sleep state. In the illustrated example, the magnet 1460 is a permanent magnet that is configured to activate only one golf ball 10 at a time. The magnet 1460 may be adjacent the ball sensor 450 such that a golf ball 10 is activated concurrently with or shortly before being detected by the ball sensor 450. The magnet 1460 is positioned between the rails 1412, 1414 toward and upper end of the rail 1414. In turn, the magnet 1460 is configured to awaken the electronics of a golf ball 10 as the golf ball 10 transitions from the rail 1412 to the rail 1414.

During a cycle of a golf ball through the ball dispenser 100 of FIGS. 1-11 and/or the ball dispenser 1000 of FIGS. 12-15, the golf ball is initially to enter the surplus hopper assembly 300 through the inlet hole 210 in its sleep state. The golf ball then travels down the rail 310, while remaining in its sleep state, as other golf balls are dispensed and/or discarded by the dispense hopper assembly 400, 1400. Eventually, the golf ball reaches the outlet end 330 of the rail 310 and waits to be transferred to the dispense hopper assembly 400, 1400. In some examples, the ball gate 340 of the surplus hopper assembly 300 transfers the golf ball from the outlet end 330 of the rail 310 of the surplus hopper assembly 300 and onto the inlet end 420, 1420 of the rail 410, 1410 of the dispense hopper assembly 400, 1400 when the dispense hopper assembly 400, 1400 is not at capacity. In other examples, the ball gate 340 is configured to transfer golf balls from the surplus hopper assembly 300 immediately after a ball dispense or discard event so that only one golf ball 10 is positioned on the rail 410, 1410 at a time. As the golf ball transfers from the surplus hopper assembly 300 and to the dispense hopper assembly 400, 1400, the golf ball transitions from being a surplus ball 20 and to a dispense ball 10.

Upon transferring onto the rail 410, 1410, the magnet 460, 1460 of the dispense hopper assembly 400 temporarily activates the electronics (e.g., a wireless transceiver, a battery, a processor, memory, etc.) of the golf ball to temporarily transition the golf ball to its active or awake state. While the golf ball is temporarily awake, the transceiver 470 wireless communicates with a wireless transceiver of the golf ball to collect a ball identifier of the golf ball and a health indicator of its battery. The golf ball then rolls down the rail 410, 1410 and away from the magnet 460, 1460 (e.g., as other golf balls are dispensed and/or discarded), and the electronics are returned to a sleep state as the golf ball waits to reach the outlet end 430, 1430 of the rail 410, 1410. That is, the rail 410 and the magnet 460 are arranged such that the golf ball returns to its sleep state upon rolling away from the magnet 460 on the rail 410. For example, the controller is configured to transmit a sleep signal for the golf ball upon receiving the ball identifier and the health indicator from the golf ball. Additionally or alternatively, the electronics of the golf ball may be configured to return to its sleep state on its own upon being awake for a predefined duration (e.g., two minutes). When the golf ball reaches the outlet end 430, 1430, either (1) the ball ram 490 discards of the golf ball or (2) the ball gate 480 dispenses the golf ball in its sleep state upon request by a player based on the determined battery-health indicator of the golf ball.

In some examples in which the dispense hopper assembly 400, 1400 is to contain only one golf ball at a time, a dispense sequence includes (1) initially opening the ball gate 480, (2) oscillating the ball gate 480 open and closed for a first predetermined duration (e.g., 300 milliseconds) to dislodge any golf ball that may jammed by the ball gate 480, (3) keeping the ball gate 480 open for a second predetermined duration that corresponds with letting one golf ball pass (e.g., 200 milliseconds), and (4) closing the ball gate 480. For example, the controller is configured to send a dispense signal to the ball gate 480 to initiate actuation of the ball gate 480 for the dispense sequence.

Such a dispense sequence may further include an operation sequence of the ball ram 490, after actuation of the ball gate 480, to discard of any extra golf ball that unintentionally remains on the rail 410, 1410. For example, to continue the dispense sequence, the controller is configured to subsequently send a clear signal to the ball ram 490 to initiate actuation of the ball ram 490 for the dispense sequence. In some examples, actuation of the ball ram 490 for the dispense sequence includes (1) pausing for a third predetermined duration (e.g., 200 milliseconds) after closing the ball gate 480 to allow any extra ball to roll to the outlet end 430, 1430 of the rail 410, 1410, (2) initially extending the ball ram 490, (3) oscillating the ball ram 490 between extended and retracted positions for a fourth predetermined duration (e.g., 300 milliseconds) to dislodge any golf ball that may jammed, (4) keeping the ball ram 490 in the extended position for a fifth predetermined duration (e.g., 200 milliseconds), and (5) retracting the ball ram 490.

Immediately after the ball ram 490 is retracted, either as part of a dispense sequence or a discard sequence, the ball gate 340 is configured to actuate to transfer one golf ball onto the rail 410, 1410. For example, the controller is configured to send a transfer signal to the ball gate 340 to cause the ball gate 340 to open for a sixth predetermined duration (e.g., 200 milliseconds) that corresponds with limiting only one golf ball to transfer onto the rail 410, 1410.

FIG. 16 depicts a block diagram of electronics 500 of the ball dispenser 100, 1000. In the illustrated example, the electronics 500 of the ball dispenser 100, 1000 includes a controller 510, which includes one or more processors 520 and memory 530.

The processor(s) 520 may be any suitable processing device or set of processing devices such as, but not limited to, a microprocessor, a microcontroller-based platform, an integrated circuit, etc. The memory 530 may include one or more of volatile memory, non-volatile memory, read-only memory, etc. In some examples, the memory 530 may include a combination of multiple kinds of memory, such as volatile memory and non-volatile memory. The memory 530 is computer readable media on which one or more sets of instructions, such as the software for operating the methods of the instant disclosure, can be embedded. The instructions may embody one or more of the methods or logic as described herein. For example, the instructions reside completely, or at least partially, within any one or more of the memory 530, the computer readable medium, and/or within the processor(s) 520 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The electronics 500 of the ball dispenser 100, 1000 also includes the ball sensor 450 and the touchscreen 240 from which the controller 510 is configured to collect data.

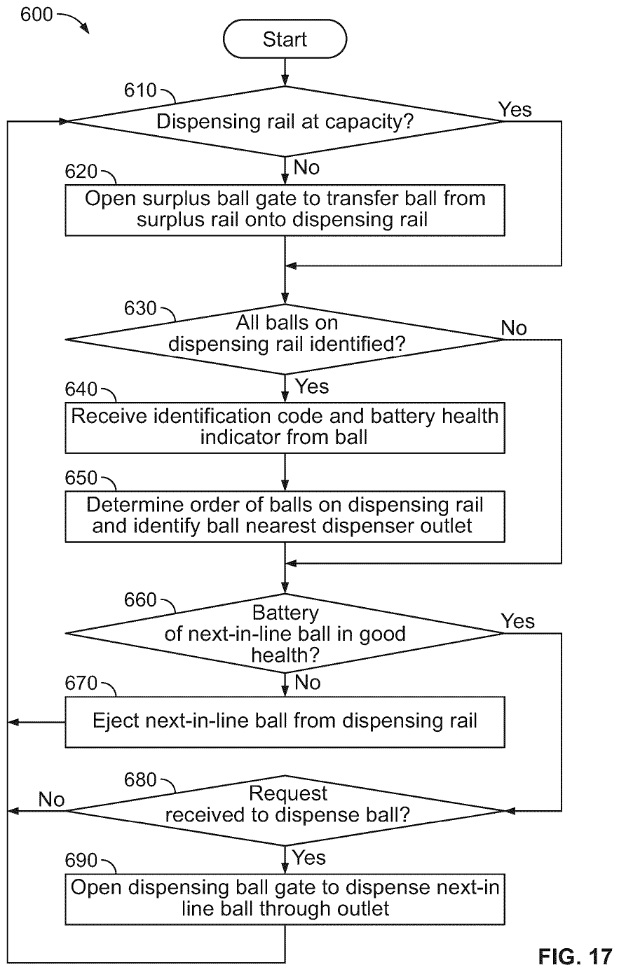

In some examples in which the dispense hopper assembly 400, 1400 is to contain a plurality of the golf balls 10 (e.g., the golf balls 10A-10F) at a time (e.g., method 600 of FIG. 17), the ball sensor 450 is configured to monitor the inlet end 420, 1420 of the rail 410, 1410 to detect when the rail 410, 1410 is at capacity with the golf balls 10. That is, the ball sensor 450 is configured to detect whether one of the golf balls 10 is at the inlet end 420, 1420. The controller 510 is then further configured to determine whether the rail 410, 1410 is at capacity based on whether the ball sensor 450 detects the absence of the golf balls 10 at the inlet end 420, 1420 for at least a predetermined duration (e.g., the first predetermined duration). In some examples in which the dispense hopper assembly 400, 1400 is to contain only one golf ball 10 at a time (e.g., method 1600 of FIG. 18), the ball sensor 450 is configured to detect when more than one ball 10 is on the rail 410, 1410. The ball sensor 450 may include a fork sensor and/or any other sensor capable of monitoring for the presence of one of the golf balls 10 at the inlet end 420, 1420 of the rail 410, 1410.

The touchscreen 240 is configured to receive a request from a player to dispense one of the golf balls 10. The touchscreen 240 also is an output device configured to present information to the player. Additionally or alternatively, the ball dispenser 100 may include other user input device(s), such as a keyboard, a mouse, a touchpad, a speech recognition system, button(s), control knob(s), and/or other input devices that are located on and/or remotely from the housing 200 of the ball dispenser 100. The touchscreen 240 and/or other user input device(s) may also be configured to receive other information from the player, such as a name, a user identification code, a payment method, etc.

The electronics 500 of the ball dispenser 100 also includes the transceiver 470 from which the controller 510 is configured to collect data (e.g., identification codes, battery-health indicators, etc.) of the golf balls 10. The transceiver 470 includes network interfaces to enable wireless communication with the network(s) and/or other computing device(s), such as the wireless transceivers of the golf balls 10. The transceiver 470 also includes hardware (e.g., processors, memory, storage, antenna, etc.) and software to control the wireless network interfaces. In the illustrated example, the transceiver 470 is communicate with the golf balls 10 via wireless personal area networks (WPANs), such as Bluetooth®; etc. For example, the transceiver 470 is configured to implement Bluetooth® Core Specification, version 5.3. That is, the transceiver 470 may be a wireless personal area networks (WPAN) transceiver. Additionally or alternatively, the transceiver 470 may be configured to communicate with the golf balls 10 via other WPANs, such as Zigbee®. Further, the transceiver 470 may communicate with the golf balls 10 via other network types, such as wireless local area networks (WLANs) (e.g., Wi-Fi®), cellular network(s) (e.g., Long-Term Evolution (LTE)), etc.

The electronics 500 of the ball dispenser 100 also includes output devices whose operation is controlled, at least in part, via the controller 510. In the illustrated example, the output devices include the actuator 344 of the ball gate 340, the actuator 484 of the ball gate 480, and the actuator 494 of the ball ram 490. In some examples, the actuator 344, the actuator 484 and/or, and the actuator 494 is a solenoid actuator.

The actuator 344 is configured to actuate the ball gate 340 between its stop position and transfer position. For example, the actuator 344 is configured extend the shaft 346 to cause the ball stopper 348 to move (e.g., lower) to its stop position to stop any of the golf balls 20 from being transferred from the rail 310 to the rail 410. In contrast, the actuator 344 is configured retract the shaft 346 to cause the ball stopper 348 to move (e.g., elevate) to its transfer position to permit the next golf ball 20A to be transferred from the outlet end 330 of the rail 310 to the inlet end 420, 1420 of the rail 410, 1410.

The actuator 344 is configured to transition the ball gate 340 to its transfer position to transfer the next golf ball 20A in response to receiving a transfer signal from the controller 510. In some examples in which the dispense hopper assembly 400, 1400 is to contain a plurality of the golf balls 10 (e.g., the golf balls 10A-10F) at a time (e.g., method 600 of FIG. 17), the controller 510 is configured to send the transfer signal in response to detecting, based on data received from the ball sensor 450, that the rail 410, 1410 is not at capacity. For example, the controller 510 is configured to send the transfer signal upon determining that the ball sensor 450 detects the absence of the golf balls 10 at the inlet end 420, 1420 for at least the predetermined not-at-capacity duration. In some examples in which the dispense hopper assembly 400, 1400 is to contain only one golf ball 10 at a time (e.g., method 1600 of FIG. 18), the controller 510 is configured to send the transfer signal immediately after the ball ram 490 returns to its rest position upon completing an actuation sequence triggered by a discard signal (e.g., to discard of an unhealthy ball) or a clear signal (e.g., to clear any remaining ball from the rail 410, 1410 after the ball gate 480 operates to dispense a ball). That is, upon actuation of the ball ram 490, the controller 510 is configured to send the transfer signal to cause the ball gate 480 to transfer another ball to the rail 410, 1410.

In some examples, the controller 510 transmits the transfer signal directly to the actuator 344 of the ball gate 340. In other examples, the ball gate 340 includes a gate controller. In such examples, the controller 510 transmits the transfer signal to the gate controller, which relays the transfer signal to the actuator 344, to cause the ball gate 340 to transition to its dispense position.

The actuator 484 is configured to actuate the ball gate 480 between its block position and dispense position. For example, the actuator 484 is configured extend the shaft 486 to cause the ball stopper 488 to move (e.g., lower) to its block position to stop any of the golf balls 10 from being dispensed. In contrast, the actuator 484 is configured retract the shaft 486 to cause the ball stopper 488 to move (e.g., elevate) to its dispense position to permit a golf ball (e.g., the next-in-line golf ball 10A) to be dispensed to a corresponding player.

The actuator 484 is configured to transition the ball gate 480 to its dispense position to dispense a golf ball (e.g., the next-in-line golf ball 10A) in response to receiving a dispense signal from the controller 510. For example, the controller 510 is configured to send the dispense signal in response to (1) receiving a dispense command via the touchscreen 240 and/or other user input device and (2) determining that the battery-health indicator (e.g., the charge level) of the golf ball at the ball gate 480 (e.g., the next-in-line golf ball 10A) is greater than a predetermined threshold (also referred to as a “predetermined battery threshold” and a “predetermined battery-health threshold”). In some examples, the controller 510 transmits the dispense signal directly to the actuator 484 of the ball gate 480. In other examples, the ball gate 480 includes a gate controller. In such examples, the controller 510 transmits the dispense signal to the gate controller, which relays the dispense signal to the actuator 484, to cause the ball gate 480 to transition to its dispense position.

The actuator 494 is configured to actuate the ball ram 490 between its rest position and discard position. For example, the actuator 494 is configured extend the shaft 496 to its discard position to discard a golf ball at the ball gate 480 (e.g., the next-in-line golf ball 10A) from the rail 410. In contrast, the actuator 494 is configured retract the shaft 496 to its rest position to permit a golf ball at the ball gate 480 (e.g., the next-in-line golf ball 10A) to remain on the rail 410.

The actuator 494 is configured to transition the ball ram 490 to its discard position to discard a golf ball at the ball gate 480 (e.g., the next-in-line golf ball 10A) in response to receiving a discard signal from the controller 510. For example, the controller 510 is configured to send the discard signal in response to determining that the battery-health indicator of the golf ball at the ball gate 480 (e.g., the next-in-line golf ball 10A) is less than or equal to the predetermined battery threshold. Further, in some examples in which the dispense hopper assembly 400, 1400 is to have only one golf ball 10 at a time, the actuator 494 of the ball ram 490 may be configured to actuate immediately after the ball gate 480 is closed, as part of a ball dispense sequence, to ensure that no golf balls 10 remain on the rail 410, 1410 prior to another golf ball 10 being transferred onto the rail 410, 1410 by the ball gate 340.

In some examples, the controller 510 transmits the discard signal directly to the actuator 494 of the ball ram 490. In other examples, the ball ram 490 includes a ram controller. In such examples, the controller 510 transmits the discard signal to the ram controller, which relays the discard signal to the actuator 494, to cause the ball ram 490 to transition to its discard position.

FIG. 17 is a flowchart of an example method 600 for operating the ball dispenser 100, 1000. For example, the method 600 is used to operate the ball dispenser 100, 1000 in instances in which the dispense hopper assembly 400, 1400 is to contain a plurality of the golf balls 10 (e.g., the golf balls 10A-10F) at a time. The flowchart of FIG. 17 is representative of machine readable instructions that are stored in memory (such as the memory 530 of FIG. 16) and include one or more programs which, when executed by one or more processors (such as the processor(s) 520 of FIG. 16), cause the controller 510 to operate the ball dispenser 100, 1000. While the example program is described with reference to the flowchart illustrated in FIG. 17, many other methods may alternatively be used. For example, the order of execution of the blocks may be rearranged, changed, eliminated, and/or combined to perform the method 600. Further, because the method 600 is disclosed in connection with the components of FIGS. 1-16, some functions of those components will not be described in detail below.

At block 610, the controller 510 determines whether the rail 410, 1410 is at capacity. For example, the controller 510 determines that the rail 410, 1410 is not at capacity in response to the ball sensor 450 detecting the absence of the golf balls 10 at the inlet end 420, 1420 for at least the predetermined not-at-capacity duration. In contrast, the controller 510 determines that the rail 410, 1410 is not at capacity in response to the ball sensor 450 detecting the presence of one of the golf balls 10 and/or the absence of the golf balls 10 for less than the predetermined not-at-capacity duration.

In response to the controller 510 determining that the rail 410, 1410 is at capacity, the method 600 proceeds to block 630. Otherwise, in response to the controller 510 determining that the rail 410, 1410 is not at capacity, the method 600 proceeds to block 620.

At block 620, the controller 510 sends a transfer signal to cause the ball gate 340 to transfer the next golf ball 20A from the rail 310 to the rail 410, 1410. For example, the controller 510 sends the transfer signal to the actuator 344 of the ball gate 340 to cause the shaft 346 to move the ball stopper 348 and, in turn, temporarily open the ball gate 340 to permit one of the golf balls 20 to transfer from the outlet end 330 of the rail 310 and onto the inlet end 420, 1420 of the rail 410, 1410.

At block 630, the controller 510 determines whether all of the golf balls 10 on the rail 410, 1410 have been identified. In some examples, the controller 510 determines whether all of the golf balls 10 have been identified based on whether a ball identification sequence or the ball transfer sequence at block 620 has been performed most recently. For example, the controller 510 may determine that the golf balls 10 have been identified if a ball identification sequence has been performed after the most recent ball transfer sequence. Conversely, the controller 510 may determine that not all of the golf balls 10 have been identified if no ball identification sequence has been performed after the most recent ball transfer sequence.

In response to the controller 510 determining that all of the golf balls 10 on the rail 410, 1410 have been identified, the method 600 proceeds to block 660. Otherwise, in response to the controller 510 determining that not all of the golf balls 10 on the rail 410, 1410 have been identified, the method 600 proceeds to block 640 to perform a ball identification sequence.

At block 640, the transceiver 470 of the ball dispenser 100, 1000 communicates with a wireless transceiver of the golf ball 10F that is adjacent the magnet 460, 1460. Specifically, when the electronics of the golf ball 10F is temporarily activated, the transceiver 470 communicates with the wireless transceiver of the golf ball 10F to receive an identification code and a ball-health indicator of the golf ball 10F. The controller 510 then identifies the identification code and the ball-health indicator of the golf ball 10F based on the communication between the transceiver 470 and the golf ball 10F. The golf ball 10F may then return to its sleep state upon providing its identification code and the ball-health indicator. In some examples, the controller 510, upon receiving the ball identifier and the health indicator, causes the transceiver 470 to transmit a sleep signal that causes the golf ball 10F to return to its sleep state. Additionally or alternatively, the electronics of the golf ball may return to its sleep state on its own upon being awake for a predefined duration (e.g., two minutes), for example, in instances in which the golf ball 10F did not receive a sleep signal transmitted by the transceiver 470.

Blocks 640 is disclosed above for the ball dispenser 100, 1000 in which the magnet 460, 1460 is a permanent magnet capable of activating only one of the golf balls 10 at a time.

In other examples, the magnet 460, 1460 may be an electromagnet. In such examples, the controller 510 may send an activation signal to cause the electromagnet to temporarily activate for a predetermined activation duration in response to determining that the rail 410, 1410 has been at capacity for at least the predetermined at-capacity duration. While activated, the electromagnet simultaneously causes the electronics of one or more (e.g., all) of the golf balls 10 positioned on the rail 410, 1410 to be temporarily activated. In some examples, the electromagnet is positioned and emits a small enough electromagnetic field to communicate with only one of the golf balls 10 (e.g., the golf ball 10F) that is nearest to the electromagnet such that the electromagnet communicates with only one of the golf balls 10 during each identification event. In other examples, the electromagnet may be positioned and emits a large enough electromagnetic field to concurrently communicate with all of the golf balls 10 positioned on the rail 410, 1410 during each identification event.

While the electromagnet is activating the electronics of one or more of the golf balls 10, the transceiver 470 of the ball dispenser 100, 1000 communicates with a respective wireless transceiver of each of the golf balls 10 that are activated to collect a respective identification code and ball-health indicator. After the predetermined activation duration has completed, the controller 510 causes the electromagnet to deactivate, which, in turn, may cause each of the golf balls 10 that were activated to also deactivate and return to their respective sleep states. The controller 510 may cause the electromagnet to deactivate by no longer sending the activation signal and/or by sending a separate deactivation or sleep signal.

At block 650, the controller 510 identifies (1) the order in which the golf balls 10 are resting on the rail 410, 1410 and (2) the next-in-line golf ball 10A that is next-in-line for dispensing. For example, the controller 510 determines the order of the golf balls 10 on the rail 410, 1410 and the next-in-line golf ball 10A that is closest to the outlet end 430, 1430 and next in line to be dispensed based on a sequence in which the identification codes of the golf balls 10 are collected during a continuous set of preceding identification events.

For example, the memory 530 may store the maximum capacity of the rail 410, 1410 (e.g., six as shown in FIG. 10), the identification codes and battery-health indicators of the golf balls 10 that were collected during the continuous set of preceding identification events, and timestamps of those identification events. The controller 510 then determines which of the golf balls 10 communicated with the transceiver 470 during the most recent activation sequence, the second most recent activation sequence, etc. until the number of balls reviewed matches the maximum capacity of the rail 410, 1410. The golf ball 10 that communicated with the transceiver 470 during the most recent activation sequence is identified by the controller 510 as the golf ball 10F that is last in line, the golf ball 10 that communicated with the transceiver 470 during the second most recent activation sequence is identified by the controller 510 as the golf ball 10F that is second to last in line, etc. In turn, the controller 510 determines (1) the order in which the golf balls 10 are resting on the rail 410, 1410 and (2) the next-in-line golf ball 10A that is next-in-line for dispensing. For example, the golf ball 10 that communicated with the transceiver 470 during the oldest of preceding identification events is identified by the controller 510 as being the next-in-line golf ball 10A that is next-in-line for dispensing.

At block 660, the controller 510 determines whether the next-in-line golf ball 10A that is next in line to be dispensed is in good health.

For example, the controller 510 identifies the battery-health indicator of the next-in-line golf ball 10A and subsequently determines whether the next-in-line golf ball 10A is in good health by comparing its battery-health indicator to the predetermined battery threshold. If the battery-health indicator of the next-in-line golf ball 10A is greater than the predetermined battery threshold, the controller 510 determines that the next-in-line golf ball 10A is in good health. Conversely, if the battery-health indicator of the next-in-line golf ball 10A is less than or equal to the predetermined battery threshold, the controller 510 determines that the next-in-line golf ball 10A is in not in good health.

In response to the controller 510 determining at block 660 that the next-in-line golf ball 10A is not in good health, the method 600 proceeds to block 670. Otherwise, in response to the controller 510 determining at block 660 that the next-in-line golf ball 10A is in good health, the method 600 proceeds to block 680.

At block 670, the controller 510 sends a discard signal to cause the ball ram 490 to discard the next-in-line golf ball 10A from the rail 410, 1410 and into a container positioned below for subsequent removal from the miniature golf facility. For example, the controller 510 sends the discard signal to the actuator 494 to cause the shaft 496 to temporarily move to its discard position to discard the next-in-line golf ball 10A from the rail 410, 1410. That is, the controller 510 sends the discard signal to the ball ram 490 in response to determining, at block 660, that the battery-health indicator of the next-in-line golf ball 10A is less than or equal to the predetermined battery threshold. Upon completing block 670, the method 600 returns to block 610.

At block 680, the controller 510 determines whether a request to dispense one of the golf balls 10 been received from a player via the touchscreen 240 and/or other user input device. In response to the controller 510 determining that no dispense request has been received, the method 600 returns to block 610. Otherwise, in response to the controller 510 determining that a dispense request has been received, the method 600 proceeds to block 690.

At block 690, the controller 510 sends a dispense signal to cause the ball gate 480 to temporarily open to dispense the next-in-line golf ball 10A (in its sleep state) from the rail 410, 1410 and to the player. For example, the controller 510 sends the dispense signal to the actuator 494 to cause the shaft 496 to move in a manner that permits the next-in-line golf ball 10A to transfer from the outlet end 430, 1430 of the rail 410, 1410 and to the player. That is, the controller 510 sends to the dispense signal to dispense the next-in-line golf ball 10A in response to (1) determining, at block 660, that the battery-health indicator of the next-in-line golf ball 10A is greater than the predetermined battery threshold and (2) receiving, at block 680, the dispense command from the touchscreen 240.

In some examples, the controller 510 collects, via the touchscreen 240, a player identification code designated for the player that has requested the dispensing of the next-in-line golf ball 10A. The controller 510 then records (e.g., in the memory 530) the player identification code of the player and the identification code of the next-in-line golf ball 10A that is dispensed.

Upon completing block 690, the method 600 returns to block 610.

FIG. 18 is a flowchart of another example method 1600 for operating the ball dispenser 100, 1000. For example, the method 1600 is used to operate the ball dispenser 100, 1000 in instances in which the dispense hopper assembly 400, 1400 is to contain only one golf ball 10 at a time. The flowchart of FIG. 18 is representative of machine readable instructions that are stored in memory (such as the memory 530 of FIG. 16) and include one or more programs which, when executed by one or more processors (such as the processor(s) 520 of FIG. 16), cause the controller 510 to operate the ball dispenser 100, 1000. While the example program is described with reference to the flowchart illustrated in FIG. 18, many other methods may alternatively be used. For example, the order of execution of the blocks may be rearranged, changed, eliminated, and/or combined to perform the method 1600. Further, because the method 1600 is disclosed in connection with the components of FIGS. 1-16, some functions of those components will not be described in detail below.

Initially, at block 1605, the controller 510 determines whether a ball is on the rail 410, 1410 waiting to be dispensed. For example, the controller 510 may determine that there is no golf ball 10 on the rail 410, 1410 based on data collected by the ball sensor 450 and/or a lack of recent communication with the transceiver 470. Additionally or alternatively, the controller 510 may assume that there is no golf ball 10 remaining on the rail 410, 1410 upon completion of a actuation sequence of the ball ram 490 (e.g., as part of a dispense sequence or for a discard sequence).

In response to the controller 510 determining that a golf ball 10 is on the rail 410, 1410 and ready for dispensing, the method 1600 proceeds to block 1610. Otherwise, in response to the controller 510 determining that a golf ball 10 is not on the rail 410, 1410 and/or not ready for dispensing, the method 1600 proceeds to block 1650 to position a golf ball 10 on the rail 410, 1410 for subsequent dispensing.

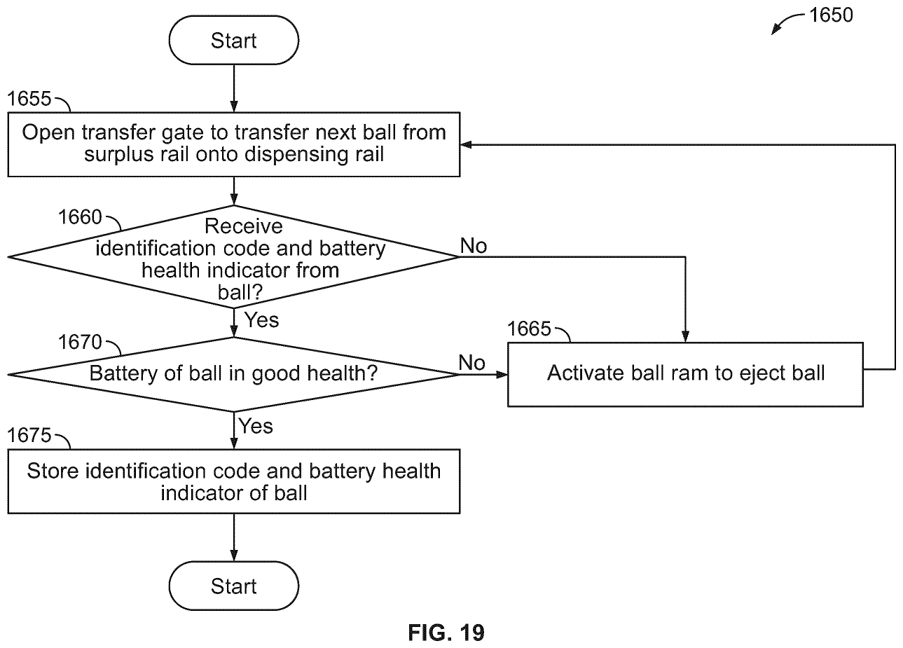

FIG. 19 is a flowchart of an example for executing block 1650 to position a golf ball 10 on the rail 410, 1410 for subsequent dispensing. The flowchart of FIG. 19 is representative of machine readable instructions that are stored in memory (such as the memory 530 of FIG. 16) and include one or more programs which, when executed by one or more processors (such as the processor(s) 520 of FIG. 16), cause the controller 510 to operate the ball dispenser 100, 1000. While the example program is described with reference to the flowchart illustrated in FIG. 19, many other methods may alternatively be used. For example, the order of execution of the blocks may be rearranged, changed, eliminated, and/or combined. Further, because FIG. 19 is disclosed in connection with the components of FIGS. 1-16, some functions of those components will not be described in detail below.

Initially, at block 1655, the controller 510 sends a transfer signal to cause the ball gate 340 to transfer the next golf ball 20 from the rail 310 to the rail 410, 1410. For example, the controller 510 sends the transfer signal to the actuator 344 of the ball gate 340 to cause the shaft 346 to move the ball stopper 348 and, in turn, temporarily open the ball gate 340 (e.g., for 200 milliseconds) to permit one of the golf balls 20 to transfer from the outlet end 330 of the rail 310 and onto the inlet end 420, 1420 of the rail 410, 1410.

At block 1660, the controller 510 determines whether the transceiver 470 has received an identification code and a ball-health indicator of a golf ball 10 that has been transferred onto the rail 410, 1410.

For example, electronics of the golf ball 10 are to temporarily activate upon the golf ball 10 passing the magnet 1460 along the rail 410, 1410. While activated, wireless transceiver of the golf ball 10 is to transmit the identification code and the ball-health indicator of the golf ball 10 to the transceiver 470 of the ball dispenser 100, 1000. In some examples, the golf ball 10 may return to its sleep state upon providing its identification code and the ball-health indicator. For example, upon receiving the ball identifier and the health indicator, the controller 510 causes the transceiver 470 to transmit a sleep signal that causes the golf ball 10 to return to its sleep state. Additionally or alternatively, the electronics of the golf ball 10 may return to its sleep state on its own upon being awake for a predefined duration (e.g., two minutes), for example, in instances in which the golf ball 10 did not receive a sleep signal transmitted by the transceiver 470.

In response to the controller 510 determining that the transceiver 470 has not receive an identification code and a ball-health indicator of a golf ball 10, the method proceeds to block 1665 at which the controller 510 causes the ball ram 490 to actuate to eject any golf ball 10 that may be resting at the outlet end 430, 1430 of the rail 410, 1410. For example, in case the transceiver 470 did not receive communication from a golf ball 10 on the rail 410, 1410 because the battery of that golf ball 10 is depleted, the controller 510 sends a discard signal to cause the ball ram 490 to discard of any golf ball 10 at the outlet end 430, 1430. Upon completion of block 1665, the method returns to block 1655 to retrieve another golf ball 10.

Returning to block 1660, in response to the controller 510 determining that the transceiver 470 has received an identification code and a ball-health indicator of a golf ball 10, the method proceeds to block 1670 at which the controller 510 determines whether the batter of the golf ball 10 is in good health. For example, the controller 510 compares the battery-health indicator of the golf ball 10 to a predetermined threshold and determines whether the battery of the golf ball 10 is in good health based on that comparison.

In response to the controller 510 determining the battery of the golf ball 10 is not in good health (e.g., its battery-health indicator is less than or equal the predetermined threshold), the method proceeds to block 1665 at which the controller 510 sends a discard signal to the ball ram 490 to cause the ball ram 490 to discard of the golf ball 10. Upon completion of block 1665, the method returns to block 1655 to retrieve another golf ball 10.

Otherwise, in response to the controller 510 determining the battery of the golf ball 10 is in good health (e.g., its battery-health indicator is greater than the predetermined threshold), the method proceeds to block 1670 at which the controller 510 stores the identification code (and the ball-health indicator) of the golf ball 10 in the memory 530 for subsequent association with a player to which the golf ball 10 is to be dispensed.

Upon completion of block 1675, the method for positioning a ball on the rail 410, 1410 for subsequent dispensing ends. Returning to FIG. 18, the method 1600 for operating the ball dispenser 100, 1000 then proceeds to block 1610.

At block 1610, the controller 510 the controller 510 determines whether a request to dispense a golf ball 10 has been received from a player, for example, via the touchscreen 240 and/or other user input device. In response to the controller 510 determining that no dispense request has been received, the method 1600 returns to block 1605. Otherwise, in response to the controller 510 determining that a dispense request has been received, the method 1600 proceeds to block 1615.

At block 1615, the controller 510 causes the ball gate 480 to dispense the golf ball 10 to the player. That is, the controller 510 sends to the dispense signal to dispense the golf ball 10 in response to (1) determining, at block 1670, that the battery-health indicator of the next-in-line golf ball 10A is greater than the predetermined battery threshold and (2) receiving, at block 1610, the dispense command from the touchscreen 240. Further, the controller 510 assigns the golf ball 10 to the player by associating the ball identifier of the dispensed ball and a player identifier of the player in the memory 530.

To dispense the golf ball 10, the controller 510 sends a dispense signal to the ball gate 480 to commence a dispense sequence. For example, to avoid the golf ball 10 from jamming at the ball gate 480, the dispense signal instructs the ball gate 480 (1) initially open, (2) oscillate between open and closed for a predetermined duration (e.g., 300 milliseconds) to dislodge any golf ball that may jammed, (3) stay open for a predetermined duration that corresponds with letting one golf ball pass (e.g., 200 milliseconds), and (4) return to a closed state.

The method 1600 then proceeds to block 1620 to continue the dispense sequence. That is, the controller 510 sends a dispense signal at block 1615 to actuate the ball gate 480 and then a clear signal at block 1620 to actuate the ball ram 490 to complete a dispense sequence. At block 1620, the controller 510 sends a clear signal to cause the ball ram 490 to actuate to eject any golf ball 10 that unintentionally remains on the rail 410, 1410. For example, the clear signal instructs the ball ram 490 to (1) pause for a predetermined duration (e.g., 200 milliseconds) after closing the ball gate 480 to allow any extra ball to roll to the outlet end 430, 1430 of the rail 410, 1410, (2) actuate to its extended position, (3) oscillate between its extended and retracted positions for a predetermined duration (e.g., 300 milliseconds) to dislodge any golf ball that may jammed, (4) remain in its extended position for a predetermined duration (e.g., 200 milliseconds), and (5) return to its retracted position.

Immediately after the ball ram 490 retracts, the method 1600, the method 1600 proceeds to block 1625 at which the controller 510 sends a transfer signal to cause the ball gate 340 to open and transfer one golf ball onto the rail 410, 1410. For example, the controller 510 instructs the ball gate 340 to open for a predetermined duration (e.g., 200 milliseconds) that enables only one golf ball to transfer onto the rail 410, 1410. Upon completing block 1625, the method 1600 returns to block 1605.

Exemplary embodiments in accordance with the teachings herein are disclosed below.
Embodiment 1. A ball dispenser includes a dispensing rail including an outlet end and on which a first set of golf balls is to rest, a magnet adjacent the dispensing rail and configured to temporarily awaken electronics of the first set of golf balls from respective sleep states, a wireless transceiver, a dispensing gate at the outlet end of the dispensing rail, and a controller. The controller is configured to receive, via the wireless transceiver, an identification code and a battery-health indicator from each golf ball of the first set of golf balls when the respective electronics is temporarily activated; identify, based on communication with the wireless transceiver, a next-in-line ball from the first set of golf balls that is closest to the outlet end; identify the battery-health indicator of the next-in-line ball; and send a dispense signal to cause the dispensing gate to dispense the next-in-line ball in the respective sleep state in response to receiving a dispense command and determining that the battery-health indicator of the next-in-line ball is greater than a predetermined threshold.
Embodiment 2. The ball dispenser of Embodiment 1, wherein the dispensing gate is configured to transition between a block position and a dispense position. The dispensing gate in the block position is configured to cause the first set of golf balls to rest on the dispensing rail, and the dispensing gate in the dispense position is configured to dispense the next-in-line ball to a user.
Embodiment 3. The ball dispenser of Embodiment 2, wherein the dispensing gate includes an actuator having a shaft that is configured to transition the dispensing gate between the block position and the dispense position.
Embodiment 4. The ball dispenser of Embodiment 3, wherein the actuator is a solenoid actuator.
Embodiment 5. The ball dispenser of Embodiment 3 or 4, wherein the dispensing gate includes a ball stopper coupled to the shaft of the actuator. The ball stopper is configured to engage the next-in-line ball in the block position and disengage from the next-in-line ball as the dispensing gate transitions to the dispense position.
Embodiment 6. The ball dispenser of Embodiment 5, wherein the dispensing gate is positioned above the dispensing rail. The ball stopper is configured to swing downward and upward as the dispensing gate transitions between the block position and the dispense position, respectively.
Embodiment 7. The ball dispenser of any of Embodiments 1-6, wherein the wireless transceiver is wireless personal area network (WPAN) transceiver.
Embodiment 8. The ball dispenser of any of Embodiments 1-7, further including a Faraday shield in which the dispensing rail, the magnet, and the wireless transceiver are at least partially enclosed to prevent the wireless transceiver from wirelessly communicating with electronic devices external to the Faraday shield.
Embodiment 9. The ball dispenser of any of Embodiments 1-8, wherein the dispensing rail further includes a receiving end. The ball dispenser further includes a ball sensor configured to detect whether one of the first set of golf balls is at the receiving end.
Embodiment 10. The ball dispenser of Embodiment 9, wherein the ball sensor is a fork sensor positioned adjacent the receiving end.
Embodiment 11. The ball dispenser of Embodiment 9 or 10, wherein the controller is further configured to determine that the dispensing rail is not at capacity in response to the ball sensor detecting a golf ball absence for at least a first predetermined duration.
Embodiment 12. The ball dispenser of any of Embodiments 1-11, further including a surplus rail on which a second set of golf balls is to rest. The surplus rail includes an inlet end and a transfer end.
Embodiment 13. The ball dispenser of Embodiment 12, wherein the surplus rail is configured to receive each of the second set of golf balls in a respective sleep state at the inlet end from a source.
Embodiment 14. The ball dispenser of Embodiment 12 or 13, further including a transfer gate at the transfer end of the surplus rail. The transfer gate is configured to transfer a next golf ball from the second set of golf balls on the surplus rail to the first set of golf balls on the dispensing rail.
Embodiment 15. The ball dispenser of Embodiment 14, wherein, in response to determining that the dispensing rail is not at capacity, the controller is further configured to send a transfer signal to cause the transfer gate to transfer the next golf ball.
Embodiment 16. The ball dispenser of any of Embodiments 1-15, wherein the magnet is a permanent magnet.
Embodiment 17. The ball dispenser of Embodiment 16, wherein the permanent magnet is configured to activate only one golf ball of the first set of golf balls at a time.
Embodiment 18. The ball dispenser of any of Embodiments 1-15, wherein the magnet is an electromagnet.
Embodiment 19. The ball dispenser of Embodiment 18, wherein the controller is further configured to temporarily activate the electromagnet for a second predetermined duration upon determining that the dispensing rail has been at capacity for at least a third predetermined duration.
Embodiment 20. The ball dispenser of Embodiment 18 or 19, wherein the electromagnet is configured to simultaneously activate all golf balls of the first set of golf balls on the dispensing rail.
Embodiment 21. The ball dispenser of any of Embodiments 1-20, wherein the controller is further configured to determine the next-in-line ball and an order of the first set of golf balls based on a sequence in which the respective identification codes of the first set of golf balls are first collected during a continuous set of preceding identification events.
Embodiment 22. The ball dispenser of any of Embodiments 1-21, further including a ball ram at the outlet end of the dispensing rail. The ball ram is configured to discard the next-in-line ball from the dispensing rail to prevent the next-in-line ball from being dispensed.
Embodiment 23. The ball dispenser of Embodiment 22, wherein the controller is configured to send a discard signal to the ball ram to discard of the next-in-line ball in response to determining that the battery-health indicator of the next-in-line ball is less than or equal to the predetermined threshold.
Embodiment 24. The ball dispenser of Embodiment 22 or 23, wherein the ball ram is oriented transverse to the dispensing rail to enable the ball ram to push the next-in-line ball off a side of the dispensing rail.
Embodiment 25. The ball dispenser of any of Embodiments 22-24, wherein the ball ram is configured to move between a rest position and a discard position. The ball ram is configured to transition to the discard position to push the next-in-line ball off the dispensing rail.
Embodiment 26. The ball dispenser of Embodiment 25, wherein the ball ram includes an actuator configured to transition the ball ram between the rest position and the discard position.
Embodiment 27. The ball dispenser of Embodiment 26, wherein the actuator is a solenoid actuator.
Embodiment 28. The ball dispenser of any of Embodiments 1-27, further including a housing in which other components of the ball dispenser are enclosed. The housing defines an outlet hole adjacent the outlet end of the dispensing rail through which the next-in-line ball is to be dispensed.
Embodiment 29. The ball dispenser of Embodiment 28, wherein the housing includes a tray below the outlet hole and onto which the next-in-line ball is to rest upon being dispensed.
Embodiment 30. The ball dispenser of any of Embodiments 1-29, further including a touchscreen configured to receive a ball request from a player.
Embodiment 31. The ball dispenser of any of Embodiments 1-30, wherein the controller is further configured to record a player identification code with the identification code of the next-in-line ball being dispensed.
Embodiment 32. A ball dispenser includes a dispensing rail including a receiving end and an outlet end, a magnet positioned along the dispensing rail and configured to temporarily awaken electronics of a golf ball from a sleep state after said golf ball has been transferred onto the dispensing rail, a wireless transceiver positioned adjacent the dispensing rail, a dispensing gate positioned adjacent the outlet end of the dispensing rail and configured to dispense said golf ball, a ball ram positioned adjacent the outlet end of the dispensing rail and configured to discard said golf ball to prevent subsequent dispensing, and a controller. The controller is configured to receive, via the wireless transceiver, an identification code and a battery-health indicator from said golf ball when said electronics is temporarily activated; compare said battery-health indicator to a predetermined threshold; send a discard signal to cause the ball ram to discard said golf ball in response to determining that said battery-health indicator is less than or equal to the predetermined threshold; and send a dispense signal to cause the dispensing gate to dispense said golf ball in response to receiving a ball request and determining said battery-health indicator is greater than a predetermined threshold.
Embodiment 33. The ball dispenser of Embodiment 32, wherein the magnet is a permanent magnet.
Embodiment 34. The ball dispenser of Embodiment 32 or 33, wherein the wireless transceiver is wireless personal area network (WPAN) transceiver.
Embodiment 35. The ball dispenser of any of Embodiments 32-34, wherein each of the dispensing gate and the ball ram includes a respective actuator.
Embodiment 36. The ball dispenser of any of Embodiments 32-35, wherein the ball ram is oriented transverse to the dispensing rail to enable the ball ram to push said golf ball off a side of the dispensing rail.
Embodiment 37. The ball dispenser of any of Embodiments 32-36, wherein the dispensing rail and the magnet are arranged such that said golf ball is to return to said sleep state upon rolling away from the magnet on the dispensing rail.
Embodiment 38. The ball dispenser of any of Embodiments 32-37, further including a second rail including an inlet end and a transfer end. Said golf ball is to remain in said sleep state when on the second rail.
Embodiment 39. The ball dispenser of Embodiment 38, further including a transfer gate at the transfer end of the second rail. The transfer gate is configured to transfer said golf ball from the transfer end of the second rail and to the receiving end of the dispensing rail.
Embodiment 40. The ball dispenser of Embodiment 39, wherein the controller is configured to send a transfer signal to cause the transfer gate to transfer said golf ball to the dispensing rail upon actuation of the dispensing gate or the ball ram.
Embodiment 41. The ball dispenser of Embodiment 39 or 40, wherein the transfer gate includes an actuator.
Embodiment 42. The ball dispenser of any of Embodiments 32-41, further including a ball sensor configured to detect a presence of said golf ball on the dispensing rail.
Embodiment 43. The ball dispenser of Embodiment 42, wherein the ball sensor is a fork sensor positioned adjacent the receiving end of the dispensing rail.
Embodiment 44. The ball dispenser of any of Embodiments 32-43, further including a housing in which other components of the ball dispenser are enclosed. The housing defines an outlet hole adjacent the outlet end of the dispensing rail through which said golf ball is to be dispensed.
Embodiment 45. The ball dispenser of any of Embodiments 32-44, further including a touchscreen configured to receive said ball request from a player.
Embodiment 46. The ball dispenser of any of Embodiments 32-45, wherein the controller is configured to record a player identification code of said player with the identification code of said golf ball being dispensed.
Embodiment 47. A ball dispenser includes a dispensing rail including a receiving end and an outlet end, a magnet positioned along the dispensing rail and configured to temporarily awaken electronics of a golf ball from a sleep state after said golf ball has been transferred onto the dispensing rail, a wireless transceiver positioned adjacent the dispensing rail, a dispensing gate positioned adjacent the outlet end of the dispensing rail and configured to dispense said golf ball, a ball ram positioned adjacent the outlet end of the dispensing rail and configured to discard said golf ball to prevent subsequent dispensing, and a controller. The controller is configured to receive, via the wireless transceiver, an identification code and a battery-health indicator from said golf ball when said electronics is temporarily activated. The controller is configured to compare said battery-health indicator to a predetermined threshold. The controller, in response to receiving a ball request and determining said battery-health indicator is greater than a predetermined threshold, is configured to send a dispense signal to cause the dispensing gate to actuate to dispense said golf ball and subsequently send a clear signal to the ball ram to discard of any golf ball remaining on the dispensing rail.
Embodiment 48. The ball dispenser of Embodiment 47, wherein the dispense signal is configured to cause the dispensing gate to open for a first predetermined duration associated with permitting only one golf ball to be dispensed at a time.
Embodiment 49. The ball dispenser of Embodiment 48, wherein, prior to opening the dispensing gate for the first predetermined duration, the dispense signal is configured to cause the dispensing gate to oscillate for a second predetermined duration to deter said golf ball from being jammed.
Embodiment 50. The ball dispenser of any of Embodiments 47-49, wherein the controller is configured to send a discard signal to the ball ram to discard said golf ball in response to determining that said battery-health indicator is less than or equal to the predetermined threshold.
Embodiment 51. The ball dispenser of any of Embodiments 47-50, wherein each of the dispensing gate and the ball ram includes a respective actuator.
Embodiment 52. The ball dispenser of claim any of Embodiments 47-51, further including a transfer gate configured to transfer said golf ball to the receiving end of the dispensing rail.
Embodiment 53. The ball dispenser of Embodiment 52, further including a second rail including an inlet end and a transfer end. Said golf ball is to remain in said sleep state when on the second rail. The transfer gate is positioned at the transfer end to transfer said golf ball from the transfer end and to the receiving end of the dispensing rail.
Embodiment 54. The ball dispenser of Embodiment 52 or 53, wherein, upon actuation of the ball ram, the controller is configured to send a transfer signal to cause the transfer gate to actuate to transfer said golf ball to the dispensing rail.
Embodiment 55. The ball dispenser of Embodiment 54, wherein the transfer signal is configured to cause the transfer gate to open for a third predetermined duration associated with permitting only one golf ball to transfer to the dispensing rail at a time.
Embodiment 56. The ball dispenser of any of Embodiments 47-55, wherein, upon receiving said identification code and said battery-health indicator from said golf ball, the wireless transceiver is configured to transmit a sleep signal to return said golf ball to said sleep state.
Embodiment 57. The ball dispenser of any of Embodiments 47-56, wherein the ball ram is oriented transverse to the dispensing rail to enable the ball ram to push said golf ball off a side of the dispensing rail.
Embodiment 58. The ball dispenser of any of Embodiments 47-57, wherein the magnet is a permanent magnet.
Embodiment 59. The ball dispenser of any of Embodiments 47-58, wherein the wireless transceiver is wireless personal area network (WPAN) transceiver.
Embodiment 60. The ball dispenser of any of Embodiments 47-59, further including a ball sensor configured to detect a presence of said golf ball on the dispensing rail.
Embodiment 61. The ball dispenser of any of Embodiments 47-60, further including a housing in which other components of the ball dispenser are enclosed.
Embodiment 62. The ball dispenser of Embodiment 61, wherein the housing defines an outlet hole adjacent the outlet end of the dispensing rail through which said golf ball is to be dispensed.
Embodiment 63. The ball dispenser of any of Embodiments 47-62, further including a touchscreen configured to receive said ball request from a player.
Embodiment 64. The ball dispenser of any of Embodiments 47-63, the controller is configured to record a player identification code of said player with the identification code of said golf ball being dispensed.
Embodiment 65. A golf facility with one or more holes and including the ball dispenser of any of Embodiments 1-64.
Embodiment 66. A golf course with one or more holes and including the ball dispenser of any of Embodiments 1-65.
Embodiment 67. A golf facility including the ball dispenser of any of Embodiments 1-65.
Embodiment 68. The golf facility of Embodiment 67, further including a course with one or more holes.
Embodiment 69. A golf game assembly including the ball dispenser of any of Embodiments 1-65.
Embodiment 70. The golf game assembly of Embodiment 69, further including a course with one or more holes.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A golf game assembly, comprising:
a ball dispenser including:
a dispensing rail including a receiving end and an outlet end;
a magnet positioned along the dispensing rail and configured to temporarily awaken electronics of a golf ball from a sleep state after said golf ball has been transferred onto the dispensing rail;
a wireless transceiver positioned adjacent the dispensing rail;
a dispensing gate positioned adjacent the outlet end of the dispensing rail and configured to dispense said golf ball;
a ball ram positioned adjacent the outlet end of the dispensing rail and configured to discard said golf ball to prevent subsequent dispensing; and
a controller configured to:
receive, via the wireless transceiver, an identification code and a battery-health indicator from said golf ball when said electronics is temporarily activated;
compare said battery-health indicator to a predetermined threshold; and
in response to receiving a ball request and determining said battery-health indicator is greater than a predetermined threshold:
send a dispense signal to cause the dispensing gate to actuate to dispense said golf ball; and
subsequently send a clear signal to the ball ram to discard of any golf ball remaining on the dispensing rail.

2. The golf game assembly of claim 1, wherein the dispense signal is configured to cause the dispensing gate to open for a first predetermined duration associated with permitting only one golf ball to be dispensed at a time.

3. The golf game assembly of claim 2, wherein, prior to opening the dispensing gate for the first predetermined duration, the dispense signal is configured to cause the dispensing gate to oscillate for a second predetermined duration to deter said golf ball from being jammed.

4. The golf game assembly of claim 1, wherein the controller is configured to send a discard signal to the ball ram to discard said golf ball in response to determining that said battery-health indicator is less than or equal to the predetermined threshold.

5. The golf game assembly of claim 1, wherein each of the dispensing gate and the ball ram includes a respective actuator.

6. The golf game assembly of claim 1, wherein the ball dispenser further includes a transfer gate configured to transfer said golf ball to the receiving end of the dispensing rail.

7. The golf game assembly of claim 6, wherein the ball dispenser further includes a second rail including an inlet end and a transfer end, wherein said golf ball is to remain in said sleep state when on the second rail, and wherein the transfer gate is positioned at the transfer end to transfer said golf ball from the transfer end and to the receiving end of the dispensing rail.

8. The golf game assembly of claim 6, wherein, upon actuation of the ball ram, the controller is configured to send a transfer signal to cause the transfer gate to actuate to transfer said golf ball to the dispensing rail.

9. The golf game assembly of claim 8, wherein the transfer signal is configured to cause the transfer gate to open for a third predetermined duration associated with permitting only one golf ball to transfer to the dispensing rail at a time.

10. The golf game assembly of claim 1, wherein, upon receiving said identification code and said battery-health indicator from said golf ball, the wireless transceiver is configured to transmit a sleep signal to return said golf ball to said sleep state.

11. The golf game assembly of claim 1, wherein the ball ram is oriented transverse to the dispensing rail to enable the ball ram to push said golf ball off a side of the dispensing rail.

12. The golf game assembly of claim 1, wherein the magnet is a permanent magnet, and wherein the wireless transceiver is wireless personal area network (WPAN) transceiver.

13. The golf game assembly of claim 1, wherein the ball dispenser further includes a ball sensor configured to detect a presence of said golf ball on the dispensing rail.

14. The golf game assembly of claim 1, wherein the ball dispenser further includes a housing in which other components of the ball dispenser are enclosed, wherein the housing defines an outlet hole adjacent the outlet end of the dispensing rail through which said golf ball is to be dispensed.

15. The golf game assembly of claim 1, wherein the ball dispenser further includes a touchscreen configured to receive said ball request from a player, and wherein the controller is configured to record a player identification code of said player with the identification code of said golf ball being dispensed.

16. A golf game assembly for a miniature golf course, comprising:
a ball dispenser including:
a dispensing rail including a receiving end and an outlet end;
a magnet positioned along the dispensing rail and configured to temporarily awaken electronics of a golf ball from a sleep state after said golf ball has been transferred onto the dispensing rail;
a wireless transceiver positioned adjacent the dispensing rail;
a dispensing gate positioned adjacent the outlet end of the dispensing rail and configured to dispense said golf ball;
a ball ram positioned adjacent the outlet end of the dispensing rail and configured to discard said golf ball to prevent subsequent dispensing; and
a controller configured to:
receive, via the wireless transceiver, an identification code and a battery-health indicator from said golf ball when said electronics is temporarily activated;
compare said battery-health indicator to a predetermined threshold;
send a discard signal to cause the ball ram to discard said golf ball in response to determining that said battery-health indicator is less than or equal to the predetermined threshold; and
send a dispense signal to cause the dispensing gate to dispense said golf ball in response to receiving a ball request and determining said battery-health indicator is greater than a predetermined threshold.

17. The golf game assembly of claim 16, wherein the ball ram is oriented transverse to the dispensing rail to enable the ball ram to push said golf ball off a side of the dispensing rail.

18. The golf game assembly of claim 16, wherein the dispensing rail and the magnet are arranged such that said golf ball is to return to said sleep state upon rolling away from the magnet on the dispensing rail.

19. The golf game assembly of claim 16, wherein the ball dispenser further includes:
a second rail including an inlet end and a transfer end, wherein said golf ball is to remain in said sleep state when on the second rail; and
a transfer gate at the transfer end of the second rail, wherein the transfer gate is configured to transfer said golf ball from the transfer end of the second rail and to the receiving end of the dispensing rail.

20. The golf game assembly of claim 19, wherein the controller is configured to send a transfer signal to cause the transfer gate to transfer said golf ball to the dispensing rail upon actuation of the dispensing gate or the ball ram.
